(19) United States
(12) Patent Application Publication
(10) Pub. No.: US 2020/0111278 A1
(43) Pub. Date: Apr. 9, 2020

(54) PURCHASER-DIRECTED BENEFICIARY POT-SHARING LOTTERY

(71) Applicant: Sean O'Hagan, Saskatoon (CA)

(72) Inventor: Sean O'Hagan, Saskatoon (CA)

(21) Appl. No.: 16/390,545

(22) Filed: Apr. 22, 2019

Related U.S. Application Data
(63) Continuation of application No. 14/714,592, filed on May 18, 2015, now abandoned.

(30) Foreign Application Priority Data
May 16, 2014 (CA) 2585189

(51) Int. Cl. G07F 17/32

(52) U.S. Cl. CPC G07F 17/32; G07F 17/329; G07F 17/3244; G07F 17/3272

(57) ABSTRACT

An electronically facilitated lottery in which the purchaser of a lottery ticket can selectively direct the beneficiary proceeds portion of their ticket purchase price to at least one lottery beneficiary. A ticketing server hosting a ticket database, in communication with a ticket sales system, allows for the sales of lottery tickets with the selection of at least one lottery beneficiary from a plurality of possible lottery beneficiaries being made at the time of sale of the ticket. Following closure of ticket sales, at least one winning ticket can be chosen and the lottery administration system can calculate the allocation of the total sales proceeds of the lottery between the at least one winning ticket and the selected beneficiaries associated with each of the sold lottery tickets.

This application is a continuation of U.S. application Ser. No. 14/714,592 filed on May 18, 2015 which is incorporated herein by reference.

This invention is in the field of electronically facilitated lotteries and raffles and more specifically provides a lottery within which individual ticket purchasers can selectively direct the beneficiary portion of proceeds of the lottery attributable to their ticket to one or more selected beneficiaries.

### BACKGROUND

Lotteries and raffles are used in many contexts, including to provide profit or fundraising opportunities for the operators, sponsors or beneficiaries thereof.

One type of lottery sees the total sales proceeds of the lottery divided between at least one winning ticket holder and the operator of the lottery or at least one designated lottery beneficiary. This could involve, independently or alongside other prizing options, awarding a fixed dollar amount as the winner proceeds to one or more selected winners from the sold ticket pool, or in some cases awarding a percentage of the total sales proceeds as the winner proceeds to at least one winning ticket holder—in accordance with a predetermined proceeds formula. This concept is often referred to as “pot sharing”, insofar as the “pot” of beneficiary proceeds is divided or shared amongst a plurality of beneficiaries or partners in the lottery.

One of issues with pot sharing lotteries or raffles is that there is risk to the seller if the predetermined proceeds formula includes a fixed prize amount for the winner proceeds, since if a large number of tickets are not sold, profitability can be affected or even destroyed. One of the ways which an operator can mitigate against this type of risk exposure is to set a percentage of total sales proceeds as the winner proceeds in the predetermined proceeds formula, but this might not be as attractive to ticket purchasers. Another way to mitigate this problem and maximize profit-raising opportunities would be to find ways to increase the ability of the vendor or operator to maximize the number of tickets sold.

The logistics of operating and selling large lotteries or raffles, including a pot sharing lottery, are significant. Large numbers of resources including human effort are required to sell tickets. If it were possible to find ways of enhancing the commercial saleability and profit taking in a lottery or raffle while minimizing or optimizing the required resource usage this would be another benefit which would be well received in the marketplace.

Market saturation is another issue which vendors of raffles or lotteries encounter. With large numbers of such tickets on offer in the marketplace, the purchaser or donor pool can become saturated with requests for the purchase of lottery tickets. Even if a person doesn't want to buy a ticket from a particular seller or fundraiser, the repeated requests for sales can lead to purchaser or donor fatigue. Finding a way to ameliorate market saturation would be another benefit—if it were possible to sell a lottery which allowed for the fundraising for many different beneficiaries, the number of tickets offered for sale separately in the market could be minimized.

Another way of minimizing the resource requirements to execute the sale of the tickets and reducing donor or purchaser fatigue in the marketplace, would be to create a means of selling a lottery or raffle which could coordinate the efforts of multiple groups of fundraisers in the execution of a single lottery. Maximum numbers of tickets could be sold, mitigating the risk of undersale and allowing for the setting of maximum prizing to make the raffle or lottery as attractive as possible to purchasers.

Prior art pot sharing methods all rely upon a set formula for division of the beneficiary proceeds of the lottery—for example by offering a raffle or lottery in which more than one beneficiary or operator participates in the sale of the tickets, and the beneficiary proceeds are equally divided amongst the operators on completion of the event. Alternatively beneficiary proceeds have also been divided in some cases on a pro rata basis amongst the operators or lottery beneficiaries based on the effort or number of tickets sold by each of the lottery beneficiaries on the lottery.

Some ticket purchasers may not want to buy a lottery ticket in such a lottery or raffle if at least one of the lottery beneficiaries was not a party that the purchaser wished to support with their portion of the beneficiary proceeds. As well, a preset system formula which would equally or formulaically divide the proceeds of the lottery amongst the beneficiaries is not always attractive to all charities or fundraising organizations as they might feel that they are undercompensated.

As the popularity of lotteries and raffles has increased there has been some innovation in electronic ticketing and lottery administration systems. The development of purpose built ticket sales hardware systems, or even web based ticket sales systems, brings a level of automation and flexibility to the offer of these types of products which has created greater opportunities for customization of products and optimization of sales or delivery. For example, the creation of ticketing server software and ticket database systems for use in the sale of tickets in lotteries or raffles such as these allows for streamlined operation, and ability to use more complex proceeds formulae and the like in the operation of these events.

The use of an electronic lottery administration system to sell and issue the tickets and administer the necessary data to allow for the conduct of such a lottery provides for the ability to sell the tickets in larger volume at a rapid pace. Electronic ticket sales hardware and software also allows for some additional flexibility in terms of the type of raffles or draws which can be delivered—in certain circumstances it may be desirable to conduct different types of raffles which include progressive proceeds or other side bets or side games, which can most easily be delivered using an electronic system but may be more difficult to administer with printed paper ticket books. The electronic systems which have been developed for use in the sales of tickets in these types of circumstances typically comprise a plurality of handheld ticket sales terminals, operatively connected by a communications network back to a central server and database. Ticket sales terminals are also occasionally referred to as raffle sales units, or RSUs. Tickets sales are conducted by operators of the ticket sales terminals/RSUs, who use those terminals to issue the tickets which were desired to be purchased by a purchaser.

The use of electronic lottery administration systems yields an opportunity to overcome some of the prior art limitations on pot sharing lotteries or raffles, and provide a new category of flexible pot sharing lottery products and methods which it is thought will be desireable both to ticket purchasers and beneficiaries who might participate in the pot sharing formulae. If the purchaser could direct their portion of the beneficiary proceeds or pot to one or more beneficiaries of their choosing, their charitable fundraising desire to participate in the lottery might be maximized, and there could be more individual motivation by the beneficiary/seller to do a good job of selling the tickets and seeking to be the selected recipient of beneficiary funds.

### SUMMARY OF THE INVENTION

The invention comprises a novel approach to the execution of an electronically facilitated raffle or lottery in which the purchaser of one or more lottery tickets could select one or more lottery beneficiaries from a list of possible lottery beneficiaries at the time of purchase of their tickets, to whom the beneficiary proceeds of the lottery associated with their tickets would be allocated at the time of closing of the lottery. This would represent an enhancement over prior art approaches in which multiple lottery beneficiaries might try to jointly sell a lottery or lottery and divide the proceeds amongst themselves on a prescribed predetermined proceeds formula which the purchaser did not influence or control. By providing an ability to allow for purchaser-selected beneficiary “pot sharing” such as this, single raffles or lotteries with larger total sales proceeds could be generated—since multiple fundraisers or sales groups could be incented to participate in the delivery of the lottery and the ticket price might even be increased, as it would be seen by purchasers as a means of supporting more than one charitable purpose or fundraising party with the purchase of a single ticket. It is believed that a method of electronic facilitation of a raffle such as this, in which the purchaser could direct or allocate the beneficiary portion of the proceeds of the lottery ticket purchase would be positively received by purchasers as operators alike.

The practice of the method of the present invention relies upon the use of a lottery administration system which comprises a ticketing server comprising ticketing server software for administering a ticket database, as well as a ticket database which is operatively connected to or hosted by the ticketing server and which comprises a plurality of ticket records. Each ticket record corresponds to a sold lottery ticket and includes data corresponding to a purchase price of the sold lottery ticket as well as a beneficiary identifier corresponding to at least one lottery beneficiary from a plurality of possible lottery beneficiaries. If all of the tickets are always sold at the same price, storage of the purchase price of sold lottery tickets in the ticket database could simply comprise storage of an indicator of a sale, versus an indicator of a particular value to the ticket but either such approach is contemplated within the scope of the present invention.

The final element of the lottery administration system which is used to practice the method of the present invention is a ticket sales system in communication with the ticketing server, via a communications network, to transact the sale of lottery tickets. The ticket sales system might be a hardware device or devices, such as a plurality of ticket sales terminals/RSUs, which were connected by a network back to the ticketing server, or in other embodiments could be a ticket sales website system which was again operatively connected with the ticketing server for the purpose of facilitating ticket sales transactions.

The method of conducting a beneficiary pot sharing lottery in accordance with the present invention, using a lottery administration system as outlined above, comprises first storing a predetermined proceeds formula for the lottery on the lottery administration system. The predetermined proceeds formula is the formula by which the total sales proceeds of the lottery will be distributed on completion of lottery ticket sales. The predetermined proceeds formula would in most cases be locked in before the commencement of ticket sales for regulatory or other purposes, since people purchasing tickets in a lottery would not want the rules of the game to be changing during the sales, but it will be understood that the predetermined proceeds formula could actually be adjusted at any time up to the allocation of funds if it should be desired to do so.

Once a predetermined proceeds formula is stored, the lottery tickets in the lottery will be sold during a ticket sales window, being a period of time within which tickets will be sold for the lottery. The sale of a lottery ticket, being a sold lottery ticket, comprises using the ticket sales system to capture the purchase price for the sold lottery ticket as well as the capture from the ticket purchaser of the selection of at least one lottery beneficiary from a plurality of possible lottery beneficiaries, being the selected beneficiaries, to whom the purchaser wishes the beneficiary proceeds of the lottery attributable to their own ticket being purchased to be distributed. Following the capture of the purchase price and the selection of the selected beneficiaries via the ticket sales system, the ticket sales system will transmit the captured purchase price in the captured selected beneficiaries to the ticketing server.

The ticketing server on receipt of a transmission of the captured purchase price and selected beneficiaries in respect of a sold lottery ticket from the ticket sales system would create a ticket record in the ticket database, which included the purchase price and the beneficiary identifier which corresponded to or otherwise identified the selected beneficiaries selected by the purchaser in the purchase of their ticket. The ticketing server could receive multiple transmissions from one or more terminals or entry points on the ticket sales system, during the ticket sales window, so that a large number of lottery tickets could be sold in accordance with the lottery administration system and method of the present invention in a very short time.

At the arrival of the closure of the ticket sales window, the next step is to close off the lottery and distribute the funds therefrom. On closure of the ticket sales window the first thing that would be done, via the software on the ticketing server, would be the selection of a sold ticket record set from the ticket database, being the subset of ticket records from the ticket database which correspond to the sold lottery tickets for the lottery in question. The sold ticket record set might include the entire contents of the ticket database in a circumstance where the lottery administration system of the present invention was only used to host and administer a single lottery at one time, or in other cases where the lottery administration system was configured as a service bureau which was able to administer the backend details of multiple lotteries at the same time, the sold ticket record set may identify or consist of only a subset of active sold ticket records from the ticket database rather than the entire contents thereof.

The total sales proceeds for the lottery would be calculated based on the contents of the sold ticket record set. If the ticket price is fixed for each ticket sold in the lottery, the total sales proceeds for the lottery could be calculated simply by multiplying the fixed ticket price by the record count in the sold ticket record set. Alternatively in other embodiments where the variable ticket purchase prices were permitted, the total sales proceeds would be calculated simply by adding up the purchase price of each of the ticket records within the sold ticket record set.

Following the calculation of the total sales proceeds for the lottery, based upon the predetermined proceeds formula for the lottery as well as the contents of the sold ticket record set, the winner proceeds and the beneficiary proceeds would be calculated. If the winner proceeds was a preset amount the calculation thereof would be straightforward, or if the predetermined proceeds formula provided a percentage calculation for winner proceeds that could also be applied to the total sales proceeds.

As well, the prescribed number of winning tickets for the lottery in question would be chosen by selecting the prescribed number of ticket records from the sold ticket record set corresponding to the number of winning tickets which were desired to be selected.

The allocation of the winner proceeds between the selected winning tickets could then be calculated as well—in some cases if there was only one winning ticket selected the winner proceeds would all be allocated to the single ticket and ticket holder thereof, or in other cases where multiple winning tickets were selected the winner proceeds can either be divided equally between them, or the predetermined proceeds formula might include an indication of an unequal division of the winning proceeds between the plurality of selected winning tickets and winning ticket records.

The final element of the method, which distinguishes the method of the present invention from the prior art and provides the key commercial benefits of the method over the prior art, is the conduct of a ticket level allocation of beneficiary proceeds of the lottery to individual beneficiaries from the list of potential beneficiaries. Following the calculation or allocation of the winner proceeds, the application of the predetermined proceeds formula and the contents of the sold ticket record set would be used to determine for each ticket record in the sold ticket record set the allocation of a portion of the beneficiary proceeds of the whole lottery which were attributable to the ticket record itself, being the ticket beneficiary proceeds, and determining the allocation of the ticket beneficiary proceeds to the selected beneficiaries identified by the beneficiary identifier stored in the related ticket record. In another iteration of the ticket level allocation of beneficiary proceeds, the ticket beneficiary proceeds could be unequally allocated amongst the selected beneficiaries, if the ticket purchaser at the time of purchase of the ticket was allowed to provide a weighting or an indication of the type of distribution which they wished to have applied to their ticket beneficiary proceeds on closure of the lottery.

The provision of a purchaser driven pot sharing approach is a novel approach to lotteries. By allowing the purchaser to decide which of a plurality of lottery beneficiaries will receive some or all of the beneficiary proceeds of the lottery attributable to their particular ticket, purchasers who wish to only support some or one of the potential beneficiaries of a lottery, be those charities or other for-profit organizations, can make that designation and hopefully will be more inclined to buy one or more tickets in the lottery if they have the ability to properly direct in accordance with their own wishes the allocation of the beneficiary proceeds attributable to their ticket purchases.

In some embodiments of the method of the present invention the sale of a lottery ticket might also comprise capturing purchaser identity details from each ticket purchaser and storing those in the related ticket record—for example a name, address or other contact coordinates might be desired to be captured for the purpose of notification of a winner when a winning ticket was selected and a lottery, or for security or audit purposes. Various types of capture can be contemplated in respect of this type of information, from providing a keyboard or other similar data entry interface on the ticket sales system which would permit for the purchaser of the ticket to enter this information at the time of the purchase transaction, through to even the use of the camera or the like to capture a photo or otherwise scan the identification of a purchaser for the purpose of rapidly capturing their identity.

In addition to the underlying method of the present invention which yields the calculation of a ticket level allocation of beneficiary proceeds in a lottery, the sale of lottery tickets might also further comprise the actual physical capture or collection of the purchase price funds from the ticket purchaser at the time of purchase of the ticket and creation of the related ticket record for their sold lottery ticket, in addition to the creation of that ticket record. Purchase funds might be collected or captured by for example electronically processing credit card transactions of the hardware and ticket sales system, or in other modified systems and approaches even the cash could be collected by the sales operator.

Another step in the method of the present invention once the ticket sales window was closed, following the calculation of the allocation of the winner proceeds and the ticket level beneficiary proceeds allocation, the winner proceeds and beneficiary proceeds could again be physically distributed to the winning ticket purchasers and the selected beneficiaries based upon the calculations of the allocation thereof at the closure of the ticket sales window. In its broadest sense the method herein is intended to cover the method of the calculation of these allocations but it will also be understood that the incorporation of the actual physical element of capturing the purchase funds from a purchaser at the time of buying a ticket, or distributing lottery proceeds to winners or to selected beneficiaries who were selected by at least one ticket purchaser as the beneficiary of the beneficiary proceeds attributable to one or more sold lottery tickets are all contemplated within the scope of the present invention.

The predetermined proceeds formula could be any kind of a data structure that provided the parameters for the practice of the remainder of the present invention. With a lottery administration system used as a service bureau, to administer the details of more than one lottery potential even for more than one operator or group of beneficiaries, the predetermined proceeds formula could vary for each lottery administered. The predetermined proceeds formula could prescribe that portion of the total sales proceeds of the lottery that are the winner proceeds, and a portion of the total sales proceeds of the lottery that are the beneficiary proceeds. The winner proceeds plus the beneficiary proceeds may total of up to less than the total sales proceeds of the lottery, if the formula is designed to permit for the capture of an operating fee or anything else to be deducted from the total sales proceeds of the lottery before the remainder of the proceeds are distributed. In addition to potentially stipulating the formula used to determine the winner proceeds and the beneficiary proceeds, the predetermined proceeds formula could also include parameters related to the number of winning tickets which would be selected in a particular lottery, and if there was to be an uneven allocation of winner proceeds amongst the winning tickets to be selected, that parameter could be stored within the predetermined proceeds formula as well.

The present invention could be practised in embodiments where the purchase price for each sold lottery ticket in the lottery is the same—for example each ticket in a particular lottery might be sold for $20 or for some other amount—or certain embodiments of the method of the present invention can provide for variable ticket pricing, where either by the choice of the purchaser or by some other type of parameters within the overall method, the purchaser could purchase a ticket for a variable ticket purchase price. For example, it may be the case that by the user interface of the ticket sales system, the purchaser could stipulate that instead of buying the base $20 ticket in the lottery, they wish to purchase a $200 ticket in the lottery, which would expose them to potentially a higher percentage or likelihood of winning the lottery, as well as potentially exposing them to the ability to allocate a larger amount of beneficiary proceeds to one or more selected beneficiaries. Again there are lots of different commercial environments or scenarios in which variable or static ticket pricing can be conceived of as beneficial and both such approaches are contemplated within the scope of the present invention.

Where variable ticket pricing was permitted in respect of sold lottery tickets, the weighting of those ticket records associated therewith in terms of the selection of winning tickets in the lottery can also be effected—for example a ticket which was purchased for a higher purchase price might be weighted more heavily or effectively receive more “virtual entries” in the lottery from which it could be drawn, than a lower priced ticket.

In addition to providing for static or variable lottery ticket pricing, the method of the present invention is also flexible in so far as it could permit for either a fixed or variable number of beneficiaries which could be selected by a particular ticket purchaser. The number of beneficiaries which could be selected could be enforced as a static number of choices across every sold lottery ticket in a particular lottery, or purchasers could be allowed to more heavily weight their distribution of beneficiary proceeds to one particular lottery beneficiary from the list by selecting only one lottery beneficiary where others might choose multiple beneficiaries as their selected beneficiaries.

In addition to the overall purchaser driven pot sharing beneficiary proceeds lottery method of the present invention, the ticketing server of the lottery administration system of the present invention is also specifically contemplated to be an inventive portion of this disclosure. The ticketing server would include a processor and a memory which stored instructions which when executed by the processor would can enter the ticketing server two administer a beneficiary pot sharing lottery wearing a portion of the total sales proceeds of the lottery, being winner proceeds, is allocated to a purchaser of at least one winning lottery ticket and a version of the total sales proceeds of the lottery, being beneficiary proceeds is allocated to at least one lottery beneficiary from a plurality of possible lottery beneficiaries. The ticketing server would accomplish this by first administering a ticket database comprising a plurality of ticket records, wherein each ticket record corresponds to a sold lottery ticket and includes data corresponding to a purchase price of the sold lottery ticket as well as a beneficiary identifier corresponding to the at least one lottery beneficiary from a plurality of possible lottery beneficiaries which might be selected by a ticket purchaser in the purchase of a particular lottery ticket. The ticketing server in addition to administering the ticket database would also communicate with the ticket sales system via a communications network to transact the sale of lottery tickets.

The ticketing server in operation would store a predetermined proceeds formula for the lottery and would then facilitate the sale of lottery tickets in the lottery during a lottery ticket sales window by, in respect of each lottery tickets sold, receiving a transmission of the purchase price and details of selected beneficiaries for that ticket from the ticket sales system via the communications network, and creating a ticket record in the ticket database corresponding to each sold lottery ticket.

Following the closure of the ticket sales window, the server and its related software along with the database would select a sold ticket record set from the ticket database, being the ticket records corresponding to the sold lottery tickets for the lottery, and calculate the total sales proceeds of the lottery based on the sold ticket record set contents. Based upon the predetermined proceeds formula and the contents of the sold ticket record set for the lottery, the server would then calculate the winner proceeds in the beneficiary proceeds, select the prescribed number of winning tickets for the lottery by selecting the prescribed number of ticket records from the sold ticket record set, and then calculate the allocation of the winner proceeds between the selected winning tickets. Finally, for each ticket record in the sold ticket record set, calculating the allocation of the portion of the beneficiary proceeds which was attributable to each said ticket record, being the ticket beneficiary proceeds, would be determined based upon the selected beneficiaries identified by the beneficiary identifier stored ticket record. By executing these calculations at the closure of the ticket sales window, the ticketing server would allow for the facilitation of a purchaser driven ticket level allocation of beneficiary proceeds in a particular lottery or raffle.

The ticketing server could communicate with a ticket sales system that comprised at least one ticket sales terminal having a user interface and ticket sales software thereon, and capable of connection to the ticketing server by a communications network, or in other embodiments, the ticketing server might communicate with a ticket sales system that was a ticket sales website system capable of communicating with the ticketing server and the ticket database along with communicating with one or more ticket purchasers via client devices accessible to the server of the website system in question.

The entire lottery administration system disclosed herein is also inventive, insofar as it is used in the delivery of the novel purchaser-driven pot sharing method herein.

The server and the software installed thereon could execute all of the variations on the method of the present invention otherwise outlined herein in terms of flexibility in different aspects of the method from numbers of winning tickets through numbers of permissible selections of beneficiaries and the like. It will be understood that any ticketing server capable of, in conjunction with instructions executed on the processor thereof, executing any embodiment of the method of the present invention as outlined elsewhere herein is explicitly contemplated within the scope of the present invention, as is the ticketing server software which could be used thereon in addition to the server itself.

Each selection of a lottery beneficiary in the beneficiary identifier of a ticket record within the sold ticket records set could have an equal total allocation value in the calculation of the allocation score for a particular selected beneficiary, or alternatively each lottery ticket sold and its corresponding ticket record could carry the same aggregate allocation score which could be divided amongst the one or more selected beneficiaries indicated in the beneficiary identifier. If each ticket record in the sold ticket record set has an equal total allocation value in the calculation of the allocation score for the selected beneficiaries, a ticket record that has more than one selected beneficiary would have the total allocation value of that ticket records divided amongst the selected beneficiaries indicated.

In addition to the ticketing server which is disclosed, there is also disclosed a non-transitory computer readable storage medium having stored thereon instructions that when executed by a processor of a ticketing server will configure the processor to perform a method of electronically facilitating a lottery based upon the sale of a plurality of lottery tickets where an apportion of the total sales proceeds being winner proceeds as allocated to a purchaser of at least one winning lottery ticket and a portion of the total sales proceeds being beneficiary proceeds is allocated to at least one lottery beneficiary. The remainder of the method which will be executed by the non-transitory computer readable storage medium and instructions thereon is as outlined with respect to the method and the ticketing server in the present application.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numerals, and where:

FIG. 1 is a flowchart showing one prior art embodiment of a method of pot sharing in lotteries, where the pot sharing formula would be determined or preset by the operator of the lottery;

FIG. 2 is a first sample data set demonstrating the ticket level beneficiary proceeds allocation method of the present invention;

FIG. 3 is a second sample data set demonstrating the ticket level beneficiary proceeds allocation method of the present invention;

FIG. 4 is a flowchart showing one embodiment of the method of the present invention;

FIG. 5 is a flowchart showing the detailed steps involved in one embodiment of the sale of a lottery ticket in accordance with the method of the present invention;

FIG. 6 is a flow chart showing the detailed steps involved in one embodiment of the closing allocation of proceeds following the closure of the ticket sales with no in a lottery in accordance with the remainder of the present invention;

FIG. 7 is a schematic diagram of one embodiment of a system architecture in accordance with the present invention, in which the ticket sales system comprises a plurality of ticket sales terminals;

FIG. 8 is a schematic drawing of one embodiment of the ticketing server of the present invention;

FIG. 9 is a schematic drawing of the key components of one embodiment of a ticket sales terminal in accordance with the present invention;

FIG. 10 is a schematic diagram of one embodiment of a ticket database in accordance with the present invention;

FIG. 11 is a block diagram of one embodiment of the ticketing server software of the present invention, showing the different software subroutines therein; and

FIG. 12 is a schematic diagram of an alternate embodiment of a system architecture in accordance with the present invention, in which the lottery administration system comprises a website system;

### DETAILED DESCRIPTION OF ILLUSTRATED EMBODIMENTS

The invention is an improved method for facilitating electronically the sales of tickets in a lottery, which allows a ticket purchaser at the time of purchase of a lottery ticket to select one or more specific lottery beneficiaries from a list of possible lottery beneficiaries to whom the portion of the beneficiary proceeds of the overall lottery which are attributable to the particular ticket sold will be allocated to. This allows the purchaser of the ticket to control the direction of their funds in the lottery, versus the administrator of the lottery doing so. This will maximize the attractiveness of lotteries administered in accordance with this method to ticket purchasers, while providing incentive and ability to multiple lottery beneficiaries to band together in the administration of lotteries of maximum size and at the highest possible ticket price, to maximize fundraising opportunities for all parties.

### Lotteries and Raffles:

Many different types of lotteries or raffles could be within the scope of the term “lottery” as used to describe the present invention. The deployment of the method of the present invention in either a lottery or a raffle context, with any necessary modifications to implement the beneficiary pot sharing method outlined herein, will all be understood to be within the scope of the present invention. It will also be understood that in certain cases there are even combination lotteries or raffles which offer more than one type of a bet or a game, and it will be understood that the practice of the method of the present invention to provide a ticket level beneficiary pot sharing approach to even one element of a multilayer game of chance such as this will also be understood to be within the scope of the present invention.

In certain cases it may even be the case that the winner proceeds an otherwise designated nonmonetary prize, and in the case of an otherwise designated prize the use of the method of the present invention in the sale of those lottery tickets resulting in the ability to allow ticket purchasers to designate the allocation of their portion of ticket proceeds to one or more beneficiaries even in this circumstance where the prize is nonmonetary or is not explicitly carved out of the total sales proceeds of the lottery is also contemplated within the scope of the present invention. All such games are referred to herein as a “lottery”.

### Beneficiary Pot-Sharing:

The concept of beneficiary pot sharing in a lottery relates to the division of a “house” portion of lottery proceeds amongst a plurality of potential recipients. For example if there are three charitable organizations working together in the sale of a lottery, they may set up a system whereby they would share the house portion or the “beneficiary proceeds” of the lottery and this general concept is referred to in the art as “pot sharing”. What has not been done to date has been the provision of a system whereby the purchaser of the ticket versus the operator of the lottery could designate the direction of the beneficiary portion of the proceeds of the ticket. Pot sharing to date has always taken the form of a system set or predetermined operator level formula. It is believed that by allowing the purchaser of a ticket to elect the direction of their beneficiary proceeds from their ticket in the lottery, that more lottery ticket purchase activity might be incented and it might be easier to sell more tickets in a lottery at a higher ticket price. Any type of a method which would use a lottery administration system to sell lottery tickets in a lottery and allow for a purchaser driven beneficiary pot sharing approach are all contemplated within the scope of the present invention.

### Prior Art:

As outlined above, the prior art methods of facilitating lotteries for which there might be multiple beneficiaries typically focused on approaches in which the formula for the distribution of beneficiary proceeds from the lottery would be established at the aggregate level, and applied against the entire remaining beneficiary proceeds of the lottery, based on a preset formula determined by the operator of the lottery or by the beneficiaries themselves, rather than by the ticket purchasers.

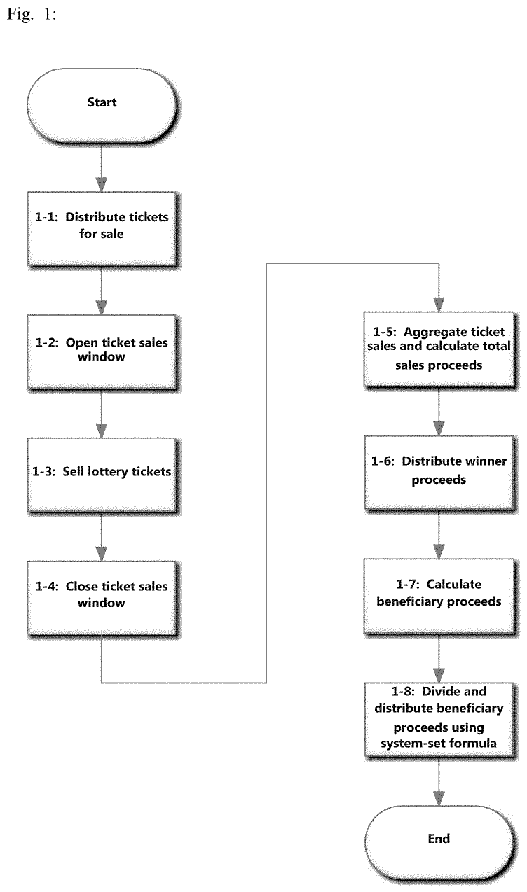

FIG. 1 is a flow chart showing one prior art method of a pot sharing lottery method in which a system-set formula is used to divide the beneficiary proceeds, which is shown for comparative purposes. Referring to that Figure, there is shown at step 1-1 the distribution of the lottery tickets for sale. This particular method could be done with the sale of paper tickets or it could be done in an electronic lottery ticket sales mode. Distribution of tickets for sale at step 1-1 in a paper ticket environment would be the distribution of ticket books to the ticket sellers representing miscellaneous or various lottery beneficiaries, to sell the tickets. In an electronic sales environment, the distribution of ticket for sale shown at step 1-1 might be the distribution or testing of ticket sales hardware such as ticket sales terminals or the like which were connected to a ticket sales system for the sale of lottery tickets.

Once the tickets had been distributed for sale, the ticket sales window could be opened. The ticket sales window is the time period within which lottery tickets in a particular lottery would be sold. The opening of the ticket sales window is show at this Figure at step 1-2. During the open ticket sales window, lottery tickets could be sold—showed at block 1-3 in the Figure. Various steps could be involved in the actual physical sale of lottery tickets depending upon the type of tickets being sold etc. The closure of the ticket sales window is shown at step 1-4—this would represent the chronological time at which lottery tickets sale would be ceased in respect of the particular lottery in question.

The next step in the prior art method shown in FIG. 1 is the aggregation of the sold tickets and ticket proceeds—collection in the context of a paper lottery might for example comprise the collection of the ticket stubs or counterfoils and the actual money etc., and the calculation of the total sales proceeds for the lottery. This is shown at step 1-5—the total sales proceeds for the lottery in the case of a traditional lottery with a fixed ticket price simply represent the fixed ticket price multiplied by the number of tickets sold. Typically there would be a preset prize for the winner or winners of the lottery in terms of participation in the total sales proceeds—sometimes a fixed dollar figure would be listed as a prize in the lottery or in other circumstances a percentage of the funds raised as total sales proceeds might be provided. In either case the distribution of the selected amount of winner proceeds to the one or more selected winning tickets and their ticket holders is shown of step 1-6.

The beneficiary proceeds which will be distributed to the plurality of selected lottery beneficiaries in respect of the lottery would be calculated based upon the remaining sum of the total sales proceeds, less the winner proceeds. Calculation of the beneficiary proceeds amount is shown at step 1-7. Once the beneficiary proceeds have been calculated, the beneficiary proceeds would be divided and distributed amongst the beneficiaries of the lottery based on the previously set system-wide formula, shown at step 1-8. The system-set formula for beneficiary proceeds distribution would be set by the operator of the lottery rather than by any input from ticket purchasers. There is not a significant amount of math and calculations involved in determining the distribution of the beneficiary proceeds using a system-wide formula and on that basis many different physical embodiments of the equipment that might be used or the method itself will be understood to those skilled in the art of gaming and ticket design as well as computer systems or other gaming equipment.

### Method Overview:

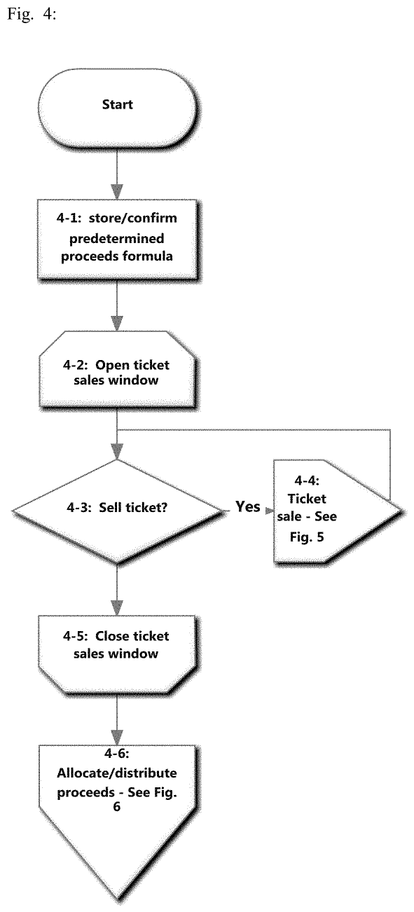

The present invention accomplishes its objective of providing for a ticket level pot sharing approach for the division of beneficiary proceeds in a lottery, by electronically facilitating a lottery based upon the sale of a plurality of lottery tickets wherein a portion of the total sales proceeds, being winner proceeds, is allocated to a purchaser of at least one winning lottery ticket and a portion of the total sales proceeds, being beneficiary proceeds, is allocated to at least one lottery beneficiary selected by the ticket purchasers. FIGS. 4 through 6 are flowcharts demonstrating one embodiment of the method of the present invention, and are described in further detail following.

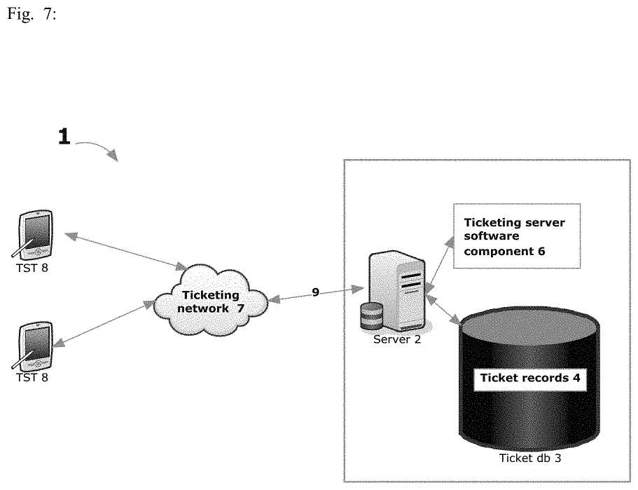

The practice of the method of the present invention relies upon the use of a lottery administration system which comprises a ticketing server comprising ticketing server software for administering a ticket database, as well as a ticket database which is operatively connected to or hosted by the ticketing server and which comprises a plurality of ticket records. Each ticket record corresponds to a sold lottery ticket and includes data corresponding to a purchase price of the sold lottery ticket as well as a beneficiary identifier corresponding to at least one lottery beneficiary from a plurality of possible lottery beneficiaries. If all of the tickets are always sold at the same price, storage of the purchase price of sold lottery tickets in the ticket database could simply comprise storage of an indicator of a sale, versus an indicator of a particular value to the ticket but either such approach is contemplated within the scope of the present invention. The final element of the lottery administration system which is used to practice the method of the present invention is a ticket sales system in communication with the ticketing server, via a communications network, to transact the sale of lottery tickets. The ticket sales system might be a hardware device or devices which were connected by a network back to the ticketing server, or in other embodiments is specifically contemplated to be a ticket sales website system which was again operatively connected with the ticketing server for the purpose of facilitating ticket sales transactions in accordance with the remainder of the method of the present invention. A sample of a lottery administration system as it is contemplated for use in the delivery or practice of the method of the present invention is shown in FIG. 7, described in further detail below.

Using the lottery administration system, the first step in the method, shown at step 4-1 in FIG. 4 is confirmation or storage of the predetermined proceeds formula. The predetermined proceeds formula is the set of parameters which will be used by the remainder of the software and the lottery administration system of the present invention to allocate the proceeds of the lottery when it is completed, using the ticket level pot sharing approach outlined herein. Storage of the predetermined proceeds formula in the memory of the server 2 might be done as part of the spin up steps towards the opening of the particular lottery ticket sales window, or the predetermined proceeds formula might also already be statically stored within the memory of the server 2 or elsewhere or accessible thereto, and it will be understood that the step of actually storing or confirming the predetermined proceeds formula in the memory or accessible to the server 2 insofar as it might comprise either the contemporaneous entry and storage of the necessary parameters to make up the predetermined proceeds formula just in advance of the opening of the ticket sales window, or alternatively simply using a predetermined proceeds formula which was already stored in or accessible to the memory of the server, both approaches are contemplated within the scope of the present invention.

It is logistically possible to adjust the predetermined proceeds formula once the sales of lottery tickets has already started for the lottery in question, although from either a regulatory or a marketing perspective it may be undesirable to do so. It will however be understood again to those skilled in the art of systems design for systems such as these that an interface could be provided by which the predetermined proceeds formula could be adjusted during the ticket sales window really or at any time up until the closure thereof and the commencement of the allocation steps of the method.

Once the predetermined proceeds formula has been set or confirmed in the method, the ticket sales window for the lottery can commence. The opening of the ticket sales window for the lottery is shown at block 4-2. The ticket sales window as outlined elsewhere herein is a predetermined period of time within which lottery tickets in the lottery in question can be sold. The ticket sales window is represented in the flowchart of FIG. 4 as a loop, extending between blocks 4-2 to 4-5.

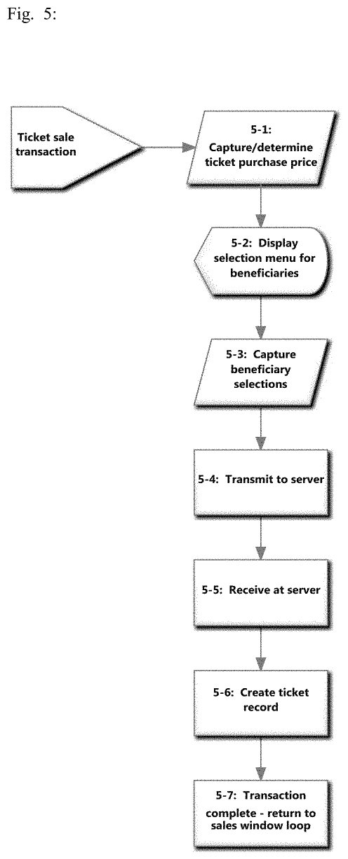

During the open ticket sales window, lottery tickets can be sold. The decision block shown at 4-3 shows a logic point at which it can be determined by the software on the server 2 whether the conditions exist within which a ticket should be sold, or alternatively the sale of a lottery ticket can also be triggered by the software resident on the ticket sales terminals or the ticket sales system, in communication or conjunction with the server. In any event, if it is desired to sell a lottery ticket in accordance with the method, the decision block shown at 4-3 on its binary positive leg shows, via block 4-4 the movement to the flowchart of FIG. 5 which demonstrates in detail the steps involved in the sale of a lottery ticket in accordance with the remainder of the invention.

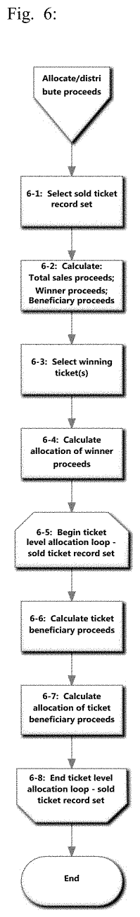

Once the ticket sales window closes, shown at block 4-5, the final step in the overall method of the present invention is shown in this Figure is the allocation and distribution of proceeds—this is shown at step 4-6, which actually is an off page link to FIG. 6 which demonstrates the steps involved in the allocation and distribution of proceeds in further detail.

Where a lottery ticket is to be sold by the ticket sales system in conjunction with the ticketing server, a subroutine resembling that shown in FIG. 5 will be triggered. Using the user interface of the ticket sales system whether that be by a website interface or a hardware interface, the purchase price of the lottery ticket to be sold, being the sold lottery ticket, is captured or determined. This is shown at block 5-1. In a case where variable ticket purchase prices were permitted in respect of the sale of lottery tickets, the user interface of the ticket sales terminal or the ticket sales website can allow for the selection of the purchase price for capture, or if the purchase price for all the tickets in the lottery was fixed, the purchase price for that particular ticket would be known from retrieval of that information from the ticketing database 3 or otherwise.

Following the capture of the ticket purchase price or the determination of the ticket purchase price for storage to the ticket record associated with the sold lottery ticket when completed, the next step which would be triggered again at the user interface of the ticket sales system, being the user facing component of the lottery administration system, would be the selection of one or more lottery beneficiaries from a list of possible lottery beneficiaries, who the purchaser of the ticket wished for their portion of the beneficiary proceeds of the lottery to be allocated. In the method embodiment shown in this Figure, there is shown at block 5-2 a display block where the ticket sales system would display a selection menu of the available beneficiary selections to its user, be that the sales vendor or the purchaser, such that the purchaser could use that menu to select one or more lottery beneficiaries, depending upon the number of beneficiaries permitted or otherwise coded into the predetermined proceeds formula or other parameters of the lottery, and the ticket sales system would then capture the beneficiary selections made by the purchaser as shown at block 5-3. There are various ways that a user of the ticket sales system could indicate selected beneficiaries in respect of a ticket sale and all are contemplated within the scope hereof.

In some embodiments of the method, purchaser identifying information would also be captured—name, address or other communication coordinates etc., for storage in the ticket database 3 along with the remainder of the details of the sold lottery ticket—this additional information and its capture is not shown in this Figure but it will be understood by those skilled in the art that the addition of more data capture steps or data capture fields to the user interface which is used either via the ticket sales terminal or the ticket sales website system could easily accommodate the capture of such additional information.

Following the completion of the capture or determination of the ticket purchase price, which in the case of a fixed price ticket might simply comprise the capture of the existence of the pending ticket sale or in the case of variable price tickets could comprise the entry or selection of a particular pricing level for the ticket being purchased, as well as the selection of one or more selected beneficiaries by the purchaser, that information will be transmitted to the server 3 from the ticket sales system 8—this is shown at block 5-4.

The server 3 could run a listener loop on its interface to the communications network 12 to receive transmissions of such information pertaining to transactions and sold lottery tickets, and when the transmission of this information was received at the server, as shown at block 5-5 it could be further processed. The receipt of a data packet at the server 3 which included the above information captured in respect of a ticket sale transaction would result in the creation of a ticket record 40 within the ticket database 3 by the ticketing server software 6—the creation of the ticket record 40 in the ticket database 3 is shown at step 5-6. Following the validation of the information and the completion of the creation of the ticket record 40 within the database 3, the ticket sales transaction would be completed—the ticket sales system and its particular user interface for a particular ticket sales terminal 8 or the like could be used to generate another ticket sale, and the ticketing server 2 could go back to listening for the receipt of additional transactions on the communications network 12 interface from the one or more hardware devices or client interfaces which could be used to generate ticket sales. Following the completion of the transaction, shown at block 5-7 in this Figure, the overall ticket sales loop shown in FIG. 4 would be resumed, until additional ticket sales were to be generated and/or captured to the database, or until the closure of the ticket sales window. Each time that the ticket sale transaction subroutine shown in FIG. 5 was executed would result eventually in the creation of an additional ticket record 40 within the ticket database 3. As outlined throughout this application, at the completion of the ticket sales window, the ticket database 3 should contain a ticket record 40 in respect of each sold ticket in the lottery.

The particular configuration of communication between the software on the ticket sales system 8 and the ticketing server 2 and the detailed methodology involved in the specific capture of a ticket sale transaction and its transmission to the ticketing server 2 for the lodging of a new ticket record 40 in the ticket database 3 can be varied. Any approach to a method that would result in the creation of records 40 in the ticket database 3 as outlined herein, using one or more network connected client interfaces to allow for the remote sale of lottery tickets at locations away from the physical ticketing server 2 is all contemplated within the scope hereof. By incorporating a listening interface on the server to capture network communications or communication packets containing the details of ticket sale transactions from multiple locations, a widely distributed ticket sales system could be used as a part of the lottery administration system 1 used to execute the method herein, resulting in the ability to sell a lottery through many multiple locations even over a wide geographic footprint and hopefully resulting in the ability to sell large quantities of lottery tickets in the execution of a single lottery.

The second subroutine, shown in FIG. 6, is one embodiment of the subroutine which will be executed upon the closure of the ticket sales window, to actually calculate the allocation and distribution of the proceeds from the lottery in question. Once a lottery ticket sales window was to close, referring back to block 4-5 in FIG. 4, the next step in the process shown at block 4-6 is to calculate the allocation and distribution of the proceeds of the lottery. An off page link to the subroutine of FIG. 6 is shown here at this step in FIG. 4.

Referring to the subroutine shown for the allocation or distribution of proceeds in FIG. 6, upon the closure of the ticket sales window, the ticketing server software component 6 and its various subcomponents or routines would, as shown at block 6-1, select the sold ticket record set from the ticket database 3. The sold ticket record set would comprise a subset of the ticket records 40 contained within the ticket database 3, representing all of the lottery tickets which were sold in a particular lottery. As outlined elsewhere herein, if the lottery administration system 1 of the present invention is being used to administer multiple lotteries on behalf of multiple parties, the sold ticket record set might represent only a small subset of the ticket records 40 contained within the ticket database 3. In other embodiments of the lottery administration system 1 where only a single lottery was being administered by the lottery administration system 1, the sold ticket record set might include all of the records in the ticket database 4.

The contents of the sold ticket record set will be used for the calculation of the allocation of proceeds from the lottery, as well as to delineate the record set from which winning tickets will be selected. Following the assembly or identification of the sold ticket record set from the ticket database 4, the next step in the method, shown at block 6-2 is the calculation of the total sales proceeds, the winner proceeds and the beneficiary proceeds in respect of the lottery, based upon the application of the predetermined proceeds formula to the contents of the sold ticket record set. These calculations will yield two important figures which are required for the completion of the remainder of the allocation method, namely the aggregate amount of winner proceeds and the aggregate amount of beneficiary proceeds. The winner proceeds is the amount of money that will be divided amongst the winning tickets which are selected from the sold ticket record set, and the beneficiary proceeds is the aggregate amount of the total sales proceeds of the lottery which will be allocated amongst the selected beneficiaries.

Following the rendering of these calculations, the next steps in the allocation portion of the method of the present invention can be completed. Shown at block 6-3 is the selection of winning tickets. The predetermined proceeds formula would be the likely data structure within which the number of winning tickets which would be selected for a particular lottery would be stored, as a parameter for use in the execution of the lottery by the remainder of the lottery administration system 1. The number of winning tickets to be selected could also be hardcoded into the lottery administration system 1, or could be stored elsewhere in another data structure or operatively connected to the necessary software components on the ticketing server 2. Some lotteries might provide for only a single winning ticket, where others might have multiple winning tickets. Another parameter, which will be discussed shortly, is a formula by which an unequal distribution of winner proceeds is made amongst multiple winning tickets.

Winning tickets would be selected by choosing ticket records from the sold ticket record set—for example if two winning tickets were to be selected in respect of a particular lottery, two ticket records from the sold ticket record set could be selected. The winning tickets can be selected in a number of ways—typically they will be selected randomly which could be done by the ticketing software component 6 using a random number generator or the like, or alternatively a traditional counterfoil method could be used where counterfoils or paper ticket stubs corresponding to each sold lottery ticket would be printed and a physical random draw will be conducted. Any type of a selection of winning tickets which can be conceived is contemplated within the scope of the present invention.

Following the selection of one or more winning ticket records from the sold ticket record set, in selection block 6-3, the allocation of the winner proceeds amongst the winning tickets could be calculated—shown at step 6-4. As outlined in other spots herein, where multiple winning tickets were selected, the winner proceeds could either be divided equally amongst them, or the predetermined proceeds formula could include parameters by which the total winner proceeds could be divided amongst the winning tickets selected.

At this stage in the method the allocation and distribution of the winner proceeds of the lottery is completed. The next number of steps relates to the allocation and distribution of the beneficiary proceeds. Shown between steps 6-5 to 6-8 is a ticket level allocation loop, looping based on the contents of the sold ticket record set. Basically what will be executed in this loop, executed once for each ticket record in the sold ticket record set, is an individual allocation of the portion of the beneficiary proceeds of the lottery which is attributable to that sold lottery ticket amongst the selected beneficiaries selected by the purchaser of that ticket. The beginning of the ticket level allocation loop is shown at block 6-5.

Commencing this loop, for the particular sold ticket record in question, the ticket beneficiary proceeds, or the portion of the aggregate beneficiary proceeds of the lottery attributable to that particular ticket, will be calculated—shown at block 6-6. Ticket beneficiary proceeds would be easily calculated in a lottery with a fixed ticket price, since the ticket beneficiary proceeds would be equal for each ticket sold. In other iterations of the method, allowing for a variable ticket pricing, it may be the case that a pro rata calculation is required to be applied against the aggregate beneficiary proceeds total for the entire lottery to determine the portion of beneficiary proceeds of the lottery which is attributable to the particular ticket in question, based upon its purchase price in relation to the purchase price of other tickets in the pool. For example if the purchase price of one ticket was $20 and the purchase price paid for another ticket was $200, the $200 ticket might have 10 times the amount of ticket beneficiary proceeds attributable thereto. Generally speaking the ticket beneficiary proceeds would represent a pro rata share of the aggregate beneficiary proceeds of the lottery as determined based on the application of the predetermined proceeds formula and based upon the purchase price paid for the ticket in relation to the purchase prices paid for other tickets by other ticket purchasers.

Following the determination of the ticket beneficiary proceeds, shown at block 6-6, the allocation of the ticket beneficiary proceeds amongst the selected beneficiaries stored in the related ticket record would be conducted. This is shown at block 6-7. If a particular ticket record related to a winning ticket included an indication of two selected beneficiaries, the ticket beneficiary proceeds would be allocated in halves to each of those two beneficiaries. If a particular ticket record included only a single selected beneficiary or was only allowed to include a single selected beneficiary, the entire ticket beneficiary proceeds would be allocated to that select the beneficiary.

The ticket level allocation loop shows its close at step 6-8—based upon the ticket level beneficiary proceeds allocation, the lottery administration system would determine the amount of the beneficiary proceeds in aggregate which was to be allocated to each of the possible lottery beneficiaries who was at least once selected as a selected beneficiary in a ticket record in the sold ticket record set. At the end of the ticket level allocation loop, a summary could be calculated of the ticket level beneficiary proceeds allocations, for use in the subsequent distribution of the aggregate level beneficiary proceeds of the lottery to the selected beneficiaries.

The steps in the calculation and allocation shown in FIG. 6 could be reordered to a degree without departing from the intention of the invention—that is to say that for example the ticket level allocation loop could physically be conducted by the software 6 in advance of the calculation of the allocation of winner proceeds amongst the winning tickets etc. as is the case with the remainder of the disclosure herein it will be understood that any approach to an electronically assisted lottery which includes a purchaser driven pot sharing method for beneficiary proceeds is contemplated to be within the scope of the present invention.

In addition to calculating the allocation or distribution of winner proceeds amongst winning tickets, and beneficiary proceeds amongst selected beneficiaries in a particular lottery, the method might also include the actual physical steps of paying those sums of money to the holders of the winning tickets or to the selected beneficiaries in question. Even where the payment step actually took place outside of the method, the system might provide a report or display of some type to its operator which would display the results of the allocation calculations at the completion thereof.

### Sold Ticket Record Set:

The sold ticket record set would represent a subset of the ticket records 40 in the ticket database 3, in respect of all of the sold lottery tickets in respect of a particular lottery. It is specifically contemplated that the method and lottery administration system 1 of the present invention could be used to provide back-office support and execution services in respect of more than one lottery and on that basis if the ticket database 3 contains more than one set of ticket records 40 in respect of lottery tickets sold in respect of more than one lottery, beyond the addition of an identifier to the ticket records 40 to correlate a particular record to a particular lottery being sold, the design and modification of the software and database structure of the lottery administration system 1 to allow for the facilitation of multiple lotteries using a single system in accordance with the remainder of the method and system of the present invention will be understood to those skilled in the art and is contemplated within the scope hereof.

Alternatively in certain embodiments where the ticketing server 2 and the ticket database 3 were used to facilitate only a single lottery, the sold ticket record set might comprise all of the ticket records 40 within the ticket database 3 and to gain both such approaches, namely a service bureau approach which would allow for the facilitation of multiple lotteries using a single system in accordance with the remainder of the lottery administration system 1 and method of the present invention, or a free standing or locally installed system which was used to facilitate only a single lottery at a time on behalf of a single operator or a single list of lottery beneficiaries.

### Total Sales Proceeds:

Another concept which is important to the overall understanding of the mathematics of the proceeds distribution method of the present invention is the concept of total sales proceeds. The total sales proceeds of a particular lottery is a total of all of the money raised from the sales of lottery tickets in that lottery. For example in a lottery where the ticket price is fixed the total sales proceeds would be simple to calculate, by multiplying the ticket sales price by the number of tickets sold. In other embodiments of the present invention, variable ticket sale prices could be permitted, in which case it would be necessary to calculate the total sales proceeds by summing the purchase price collected in respect of each ticket represented by a ticket record 40 in the sold ticket record set, to come up with the total sales proceeds.

As outlined elsewhere above, the total sales proceeds might total the winner proceeds and the beneficiary proceeds together, or in other circumstances the winner proceeds and the beneficiary proceeds may not total the total sales proceeds and there may be some administrative charge or other fees levied against the total sales proceeds in addition to the winner proceeds and the beneficiary proceeds being extracted there from.

### Winning Tickets:

The predetermined proceeds formula in respect of a lottery would include parameters for use by the remainder of the lottery administration system around the number of winning tickets which would be selected in a particular lottery. For example some lotteries might have only a single winning lottery ticket, where other lotteries might have multiple winning lottery ticket therein and both such approaches are contemplated within the scope hereof.

Furthermore where a lottery contains parameters allowing for a plurality of winning tickets, those winning tickets could participate equally in the division of winner proceeds in the lottery, or the predetermined proceeds distribution formula might include further parameters around the weighted distribution of the winner proceeds that is to say that for example the first winning tickets selected might get a larger portion of the winner proceeds than others subsequently chosen etc. There are infinite combinations with respect to this particular aspect of the present invention.

### Predetermined Proceeds Formula:

The predetermined proceeds formula would physically comprise any data structure in which the necessary parameters to practice the proceeds allocation in accordance with the remainder of the present invention could be stored. The predetermined proceeds formula could be stored within the ticket database 3, or in a separate data structure. The predetermined proceeds formula could be hard coded into the lottery administration system 1 such that there was no ability to adjust it, or alternatively a user interface could be provided either on the ticket server 2 or on the ticket sales system to allow for a user to access and modify the parameters stored within the predetermined proceeds formula for a lottery. The predetermined proceeds formula could even in certain embodiments simply be designed or coded directly into the ticketing server software component 6. The varying means of rendering the predetermined proceeds formula usable and accessible in the lottery administration system 1 in accordance with the remainder of the invention will be understood to those skilled in the art of computer programming and all such approaches are contemplated within the scope of the present invention.

It is also specifically contemplated that where the lottery administration system 1 were used to administer more than one lottery in accordance with the present invention, the predetermined proceeds formula could be the same for each lottery, or could be separately set and varied for each lottery which is the more likely approach, since each lottery operator would likely want to take a slightly different approach to allocation of proceeds and the like.

### Sample Mathematics and Game Theory:

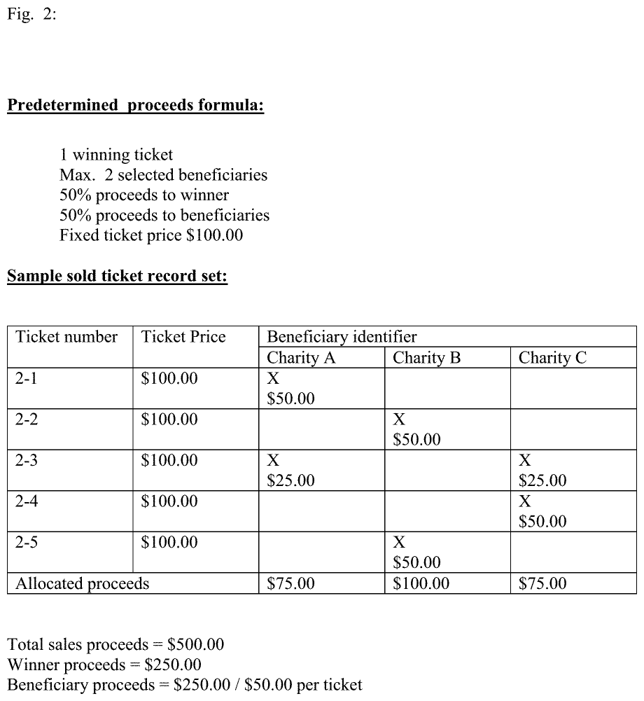

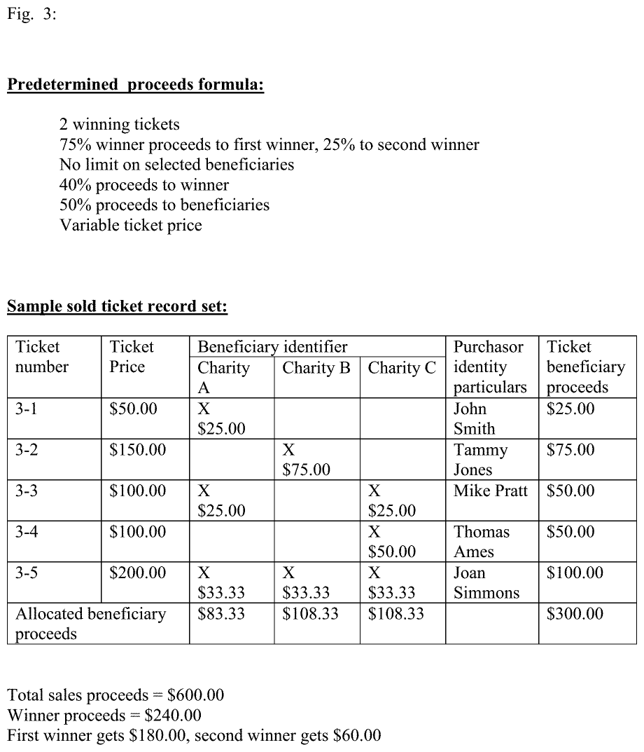

FIGS. 2 and 3 show two small sample data subsets which have been created to demonstrate the game theory and the mathematics behind the ticket-level pot sharing approach contemplated within the present invention.

Referring first to FIG. 2, there shown a sample sold ticket record set with respect to a particular lottery—this particular sold ticket record set shown in this Figure contains 5 ticket records, pertaining to tickets numbered 2-1 through 2-5. In terms of the particular lottery being conducted with respect to this particular sold ticket record set, for demonstration purposes the predetermined proceeds formula provided therein includes parameters including the fact that there would be one winning ticket selected in respect of the lottery, and that each ticket purchaser could select a maximum of two lottery beneficiaries from the list of potential lottery beneficiaries, to be codified in the beneficiary identifier stored to the ticket record and the ticket database corresponding to the particular sold lottery ticket. Further parameters in the predetermined proceeds formula demonstrated in this Figure are the fact that 50 percent of the total sales proceeds are allocated to the winner as winner proceeds, and the remaining 50 percent of the total sales proceeds are allocated to the beneficiaries as the beneficiary proceeds. A fixed ticket price of $100.00 is shown.

Looking at the tickets and the ticket records demonstrated in the dataset in further detail, it can be seen that ticket 2-1 includes a selection of a single beneficiary, resulting in a beneficiary identifier to be stored to the corresponding ticket record along with the ticket price of $100.00 which would correspond only to charity A. Moving onto record 2-2, the ticket price of $100.00 will be stored along with a beneficiary identifier of only charity B. Tickets 2-4 and 2-5 similarly include designations of single beneficiaries from the list of potential lottery beneficiaries and as such each of those 4 ticket records would include a beneficiary identifier that identified only a single lottery beneficiary being a selected beneficiary. Ticket 2-3 as shown in this Figure is a ticket in which the purchaser has designated 2 lottery beneficiaries as the selected beneficiaries—namely charity A and charity C. A beneficiary identifier identifying the fact that both of those beneficiaries were selected as the selected beneficiaries by the particular ticket purchaser would be stored along with the ticket number and the ticket price to the ticket record in the ticket database etc. Only five ticket records are shown in the data in this Figure but it will be understood that the method of the present invention is specifically contemplated to be applicable to lotteries with as many thousands of tickets being sold. The same type of a method would be approached or undertaken by the software of the lottery adminstration system of the present invention with respect to each ticket sold regardless of the number tickets which were decided to be sold or which were in actuality sold in respect of a lottery.

With the five tickets shown in this FIG. 2, the total sales proceeds for this particular lottery would be $500.00. Based on the 50 percent allocation of the total sales proceeds as winner proceeds, the winner would get $250.00 as shown by the indication of winner proceeds in the Figure. One ticket would be selected from the dataset to be awarded the $250.00 prize. The other 50 percent of the total sales proceeds is indicated in the predetermined proceeds formula herein to be allocated as beneficiary proceeds. That means that the other $250.00 of the total sales proceeds, or a total of $50.00 per ticket, would be allocated at the ticket level to the beneficiaries designated by the ticket purchaser in respect of each particular ticket. The amounts of beneficiary proceeds which are allocated to individual charities are shown in the table along with the remainder of the information for each of the five ticket records shown in this Figure—for example tickets 2-1, 2-2, 2-4 and 2-5 would each result in the allocation of $50.00 of beneficiary proceeds to their respective charities since they correspond to tickets which they each had a single charity chosen as the selected beneficiary, and with respect to ticket 2-3, $25.00 of beneficiary proceeds would be allocated to each of charity A and charity C on the basis that both of those charities were chosen by the purchaser of that particular ticket. The aggregated allocated proceeds with respect to each of the charities is also shown at the bottom of table—that is to say that charity A would receive $75.00 in total beneficiary proceeds, charity B would receive $100.00 in total beneficiary proceeds, and charity C would also receive $75.00 in total beneficiary proceeds.

Referring next to FIG. 3, there is shown a second sample sold ticket record set with an altered predetermined proceeds formula from that used in FIG. 2. The predetermined proceeds formula in this particular Figure specifies two winning tickets, with 75 percent of the winner proceeds to go to the first winning ticket and 25 percent to go to the second winning ticket. There is no limit on the number of beneficiaries which can be selected from the beneficiary's listing. 40 percent of the total sales proceeds of the lottery will be the winner proceeds, 50 percent of the total sales proceeds will be beneficiary proceeds, and 10 percent of the total sales proceeds being reserved as administration funds or otherwise deducted against the total amount. This particular lottery also permits for the sale of tickets for varied ticket prices.

This Figure again shows five ticket records, numbered 3-1 through 3-5. Varying ticket prices are also shown in the table. Tickets 3-1, 3-2 and 3-4 each designate a single selected beneficiary. Ticket 3-3 designates two selected beneficiaries and ticket 3-5 designates all three charities as selected beneficiaries. The beneficiary identifier in each ticket record would again identify the charities which were selected as the selected beneficiaries for a particular ticket by its purchaser. Also shown in the sold ticket record set of this Figure are demonstrative purchaser identity particulars which have been captured in respect of each ticket record—the names of each ticket purchaser are shown in the table. The purchaser identity particulars might include other information as well but this is put in the chart for demonstrative purposes.

In this particular lottery the total sales proceeds are $600.00. Based on the 40 percent allocation of winner proceeds the total winner proceeds is $240.00. The first winner chosen would get $180.00 and the second winner chosen would get $60.00 based on the predetermined proceeds formula.

This sample sold ticket record set in this Figure is better demonstrative of some of the complexity and flexibility of the ticket-level pot sharing approach which is the crux of the present invention. Applying the predetermined proceeds formula shown here, 50 percent of the ticket price of each ticket would be the ticket-level beneficiary proceeds which could be allocated to the selected beneficiaries identified by the beneficiary identifier in that particular ticket record—thus for example, 50 percent of the ticket sale price for each lottery ticket which had a single charity or selected beneficiary indicated in the beneficiary identifier would result in 50 percent of the ticket sale price going directly to that particular charity or selected beneficiary. In the case of ticket 3-3 where there are two beneficiaries identified, the $50.00 ticket beneficiary proceeds would be allocated equally between those two charities, and in the case of ticket 3-5 as is shown, the $100.00 in ticket beneficiary proceeds being 50 percent of the $200.00 ticket purchase price would be equally divided amongst all three charities for an allocation of $33.33 of beneficiary proceeds to each of those three charities in respect of that particular ticket. The totals of allocated beneficiary proceeds for each charity are also shown in the chart—the ticket-level allocation or pot sharing of beneficiary proceeds, based on a selection of one or more selected beneficiaries from a list of potential lottery beneficiaries by the ticket purchaser at the time they purchased the lottery ticket is the key element of the method of the present invention.

### Illustrative Environment and System Architecture:

FIG. 7 shows an illustrative architecture of the overall lottery administration system 1 of the present invention, in which ticket sales personnel can use a ticket sales system which in this case comprises ticket sales terminals 8, interacting with a ticketing server 2, to sell and issue lottery tickets to purchasers in accordance with the remainder of the present invention. The lottery administration system 1 shown in this Figure uses a plurality of ticket sales terminals 8 for the ticket sales system. As outlined elsewhere below in another embodiment, the ticket sales system might comprise a website system through which tickets could be sold.

The ticketing server 2 might include various software applications to manage aspects of interaction between various components of the lottery administration system 1, the server 2 or the ticket sales terminals 8. Software applications on the ticketing server 2 would include ticketing server software 6, responsible for the administration and handling of the method of the present invention. The server 2 would host or be connected to a ticket database 3, which was accessible to the software applications thereon and which would comprise a dataset 4 of ticket records 40 corresponding to lottery tickets which were sold in accordance with the method of the present invention.

The ticket sales terminals 8 would be connected to the ticketing server 2 via a communications network 12. The communications network 12 could be any type of a communications network capable of communication between the ticketing server 2 and the ticket sales terminals 8. It could be a wide area network, local area network or otherwise. The ticket sales terminals 8 might be statically connected so they had constantly open communications with the ticketing server 2, or some embodiments of the lottery administration system and method of the present invention could have the ticket sales terminals 8 with redundancy or purpose-built software allowing for periodic or intermittent communication sessions with the ticketing server 2. For example if the communications network 12 were wireless and it was desired to allow for the sales of tickets on an ongoing basis even when the wireless communication was not available to the ticket sales terminals 8, the lottery administration system 1 could allow for periodic handshaking and communication between the ticket sales terminals 8 and the ticketing server 2 for the sake of transmitting sold ticket particulars and other information to the ticketing server 2 for the creation of the necessary ticket records 40 in the database 3 related to sold lottery tickets which were sold since the last communication. The communications network 12 might be any combination of multiple different types of networks, such as cable networks, local area networks, personal area networks, wide area networks, the internet, wireless networks, ad hoc networks and mesh networks or the like.

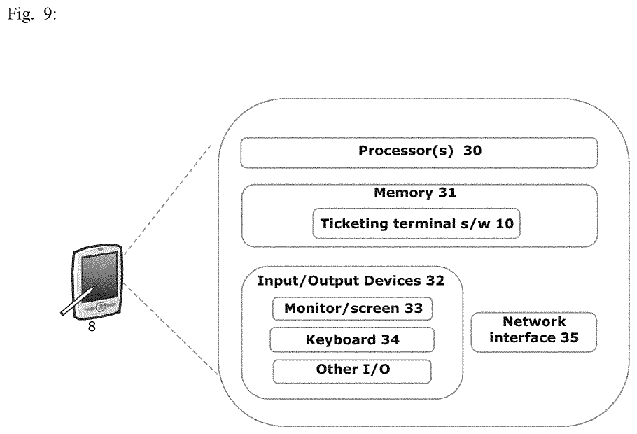

The ticketing server 2 might house or otherwise connect to one or more data stores of various information which are required for the operation of the method of the present invention. Specifically, the embodiment demonstrated in FIG. 9 shows a ticket database 3 which was operatively connected and accessible thereto with any number of subsets of data files stored therein. Different types of data structures which will each accomplish the same overarching method of the present invention are possible.

The architecture which is shown in FIG. 7 shows the ticketing server 2 along with two ticket sales terminals 8. Also shown is the communications network 12. These components are shown purely for demonstrative purposes and it will be understood that many different types of network architectures or system components and setups could be developed which would still accomplish the method outlined herein and all are contemplated within the scope of the present invention.

The ticketing server 2 along with the software and database components accessible and installed thereon will conduct the central administrative portion of the method of the present invention. The ticket sales terminals 8, as outlined in further detail elsewhere below, would provide a user interface by which a ticket seller and/or a purchaser could enter information for the generation of a lottery ticket sale, including the selection of at least one lottery beneficiary in terms of that sale, and the terminal 8 would then transmit that necessary information back to the ticketing server 2 via the communications network 12 for the use in the creation of a ticket record 40 corresponding to the sold lottery ticket. The user interface of the ticket sales terminals 8, or alternatively a user interface on the ticketing server 2, can also be used to interact with the ticket database 3 and the remainder of the software thereon for the purpose of either administering contents of the database, adjusting the predetermined proceeds formula or the like.

Generally speaking the infrastructure or architecture of this ticket sales network as is outlined in this Figure will be understood to those in the art of the design and implementation of lottery and raffle sales networks. Similar hardware is already used in many environments to sell lottery and raffle tickets, and could be used in this case as well with the necessary software modifications to allow for the practice of the business method of the present invention.

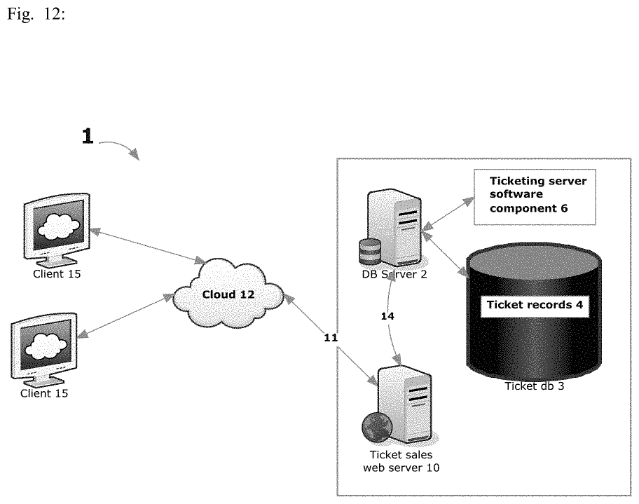

FIG. 12 shows an alternate embodiment of the lottery administration system of the present invention, in which the ticket sales system comprises a website system rather than the plurality of ticket sales terminals 8. The lottery website system comprises a lottery sales Web server 10 operatively connected in such a way that it can interact with the ticketing server 2 and the ticket database 3 as well as with a plurality of client devices 15 through which ticket sellers or ticket purchasers could interact with the remainder of the lottery administration system and engage in lottery ticket sales transactions.

### Ticketing Server:

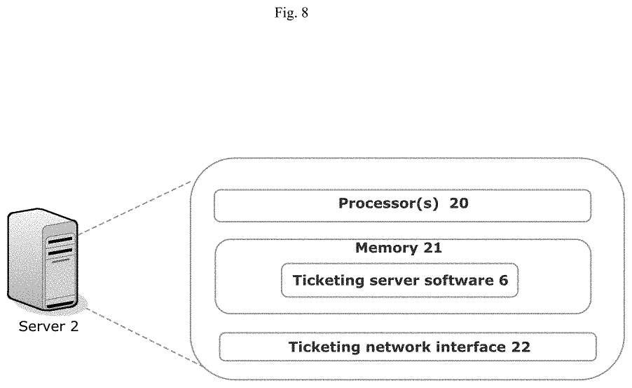

The method of the present invention and the overall architecture would be client/server in nature and would rely upon a lottery administration system 1 which was capable of communicating with the field. FIG. 8 outlines an illustrative embodiment of a ticketing server 2 in accordance with the present invention. One or more ticketing servers 2 might be implemented in the method of the present invention—a single server or a server farm approach. The server or servers 2 would each compromise one or more processors 20 and memory 21. The memory 21 might contain various software components or a series of processor instructions for use in the method of the present invention or otherwise in the operation of the ticketing server 2. Processor instructions corresponding to the ticketing server software 6 are shown stored within the memory 21.

The server 2 hosts or is operatively connected to the ticket database 3. In addition to the necessary general operating system instructions and the like the ticketing server 2 would compromise a ticketing server software component 6 which would be responsible for execution of the method of the present invention at the server end, and the ticketing server software component 6 might itself act as the interface between the remainder of the hardware and software of the ticketing server 2 and the ticket database 3, or the ticketing server 2 might alternatively include additional software interface to the ticket database 3 with which the ticketing server software component 6 and its various subroutines could communicate.

The ticketing server software component 6 would comprise subroutines for the purpose of administering the ticket database 3, creating and modifying ticket database transactions and ticket records 40 in interaction with the ticket sales terminals 8, calculating the distribution or allocation of ticket level beneficiary proceeds on closure of a lottery, as well as executing searches and reporting against the ticket database 3 as might be required. The details of the operation of the ticketing server software 6 are outlined herein.

Also shown on this Figure is a communications network interface 22. The communications network interface 22 would be the necessary hardware and software components resident on or installed upon the ticketing server 2 which would allow the ticketing server 2 to communicate with the ticket sales terminals 8 or other components of the ticket sales system as well as any other components in the issuance of tickets. The communications network interface 22 could again be by any wired or wireless interface using a network protocol allowing the ticketing server 2 to communicate with the ticketing devices 9 over a wide or local area.

### Ticketing Server Software:

The ticketing server software component 6, resident on or accessible to the server 2, would be key to the performance of the present method. It is specifically contemplated that the functions of the ticketing server software component 6 would include creation and administration of ticket records 40 within the ticket database 3, interaction with the ticket sales terminals 8 or the lottery sales website for the purpose of gathering information from the purchasers or operators and from those devices 8 for the creation or updating of ticket records 40 within the database 3, as well as other query or reporting functions. Each of the software functions or modules could be freestanding software applications or subroutines within the memory or storage of the server 2 or alternatively they could each be functions of a consolidated software program—both such approaches are contemplated within the scope of the present invention.

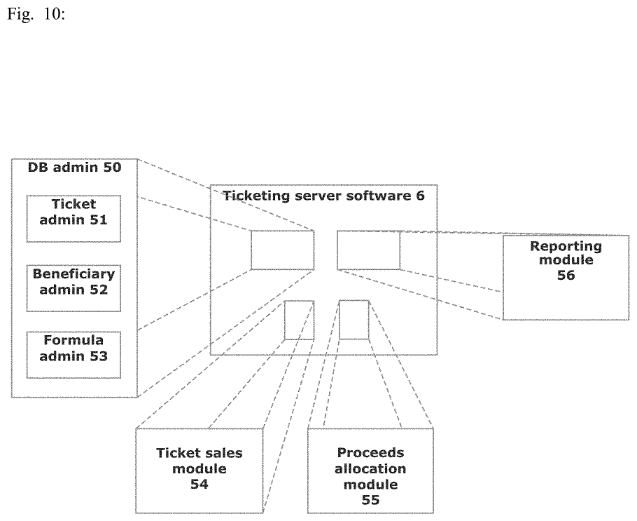

Referring to FIG. 10 there is shown a block diagram demonstrating the different subroutines or software components which are contemplated to be disposed within the ticketing server software component 6. As outlined elsewhere and will be understood to those skilled in the art, these functions might all be built into a single program or might be in freestanding program modules—this Figure is intended merely to demonstrate one approach to the architecture of the ticketing server software component 6 that could accomplish the method of the present invention.

The creation and administration of records within the ticket database 3 would be conducted by a database administration module 50. The database administration module 50 as shown in this Figure includes a number of subroutines, intended to delineate the fact that the database administration component 50 would actually potentially administer numerous subsets of data stored within the database 3.

The first function of the database administration module 50 would be the administration of ticket records 40 within the ticket database 3. A ticket administration module or subroutine is shown at 51. Upon receipt of a transmission from the ticket sales system of the details of a sold lottery ticket, the ticket administration subroutine 51 could parse that transmission or information into the necessary details required to create a ticket record 40 within the ticket database 3 corresponding to the ticket which had been sold. There might be other maintenance routines which may need to be performed from time to time on ticket records 40 within the ticket database 3 as well and the ticket administration module or subroutine 51 could also be programmed to accomplish these objectives.

Certain embodiments of the present invention might include the maintenance of a beneficiary dataset within the database 3. It might be desired to create a set of beneficiary records 5 within the database 3 to store various information with respect to particular lottery beneficiaries who were selectable as possible lottery beneficiaries during the purchase of a ticket in a particular lottery administered in accordance with the remainder of the lottery administration system. A beneficiary admin module 52 is shown—in embodiments of the ticketing database 3 or other data structures in accordance with the remainder of the present invention which included information being maintained in the lottery administration system about various selected or selectable beneficiaries, the beneficiary admin module 52 could be used.

Also shown is a predetermined proceeds formula administration module 53. It may be necessary to provide a software module which could interface with the user interface of the ticketing server hardware or otherwise, to allow user interaction and adjustment or refinement of the predetermined proceeds formula with respect to a particular lottery. As with the other subroutines or modules outlined above, the predetermined proceeds formula administration module might comprise a freestanding software module or subroutine, or this functionality might be built elsewhere into the software resident on the ticketing server 2.

In addition to the database administration module 50 and its subroutines, this Figure also shows a specific ticket sales module 54. It is contemplated that the ticketing server software 6 would include a ticket sales module 54 of some type which effectively comprised the software module capable of listening on the network interface of the server 2 for the receipt of transmissions of particulars related to lottery tickets sold, and the parsing or passing of that information through to other subroutines in the ticketing server software 6 potentially including the ticket administration subroutine 51 for the creation of ticket records 3 within the ticket database 2. The ticket sales module 54 as shown would be one of the key subroutines of the ticketing server software 6.

Shown separately from the ticket sales module 54 is a proceeds allocation module 55. The proceeds allocation module 55 is conceived to be the software subroutine, within the ticketing server software 6, which would conduct the calculations related to the actual allocation of winner proceeds and beneficiary proceeds, at the closing of the ticket sales window in accordance with the remainder of the method of the present invention. Again as with other subroutines shown in this Figure, the proceeds allocation module 55 might be a freestanding software module or program within the memory of the server 2, or might comprise one function in an integrated ticketing server software component 6 and all such approaches are again contemplated within the scope of the present invention.

Also shown in this Figure is a reporting module 56—this is merely shown to demonstrate that there could be the addition of other querying, reporting, or other functionality on top of the basic functions of the lottery administration system and method of the present invention—it might be desired to provide for an ability to generate different types of reports based upon the contents of the ticket database 3, and a reporting module 56 or a reporting configuration of a pre-existing reporting system on the database server of the present invention could be used.

The ticketing server software component 6 might also include a random number generator or the other necessary software instructions to enable the selection of winning tickets from ticket records in the ticket database where random selection was required. Alternatively if manual draw was the preferred approach with respect to a particular implementation of the software and method of the present invention, the ticketing server 2 might be operatively connected to a counterfoil printer and the software server component 6 might include the necessary additional query and reporting components to allow for the printing of counterfoils corresponding to active tickets and active ticket records within the database 3 for the purpose of the conduct of the manual draw where required.

It will be understood that the sample of the ticketing server software component 6 shown in this Figure is really only indicative of the type of functionality which would be used in the ticketing server software component 6 in accordance with the present invention.

The ticketing server software component 6 would be capable of installation and operation on the ticketing server 2, and listening on the communications network 12 in conjunction with the server hardware and receiving transmissions from the ticket sales system of the particulars of sold lottery tickets—particularly the purchase price and/or the selected beneficiaries selected by a purchaser of the ticket along with potentially purchaser identity details or any other information that was designed and captured in the process of the ticket sales transaction. Upon receipt of such a transmission, the ticketing server software component 6 would create a ticket record in the ticket database.

The ticketing server software component 6 would then, following the closure of the ticket sales window, based upon the selection of a sold ticket record set and the application of the predetermined proceeds formula, determine the allocation of the total sales proceeds of the lottery, amongst winners, beneficiaries or other purposes. The ticketing server software component 6 itself is considered to be one embodiment of the method of the present invention which is specifically claimed and covered herein. A ticketing server software component 6 which could be installed on the ticketing server for the purpose of the administration of the ticketing database and otherwise operating the method of the present invention is specifically contemplated to be within the scope of the present invention.

### Ticket Database:

There is also included a central ticket database 3 in which ticket records 40 which pertain to individual lottery tickets sold in accordance with the remainder of the present invention will be stored. Sold ticket particulars would be stored in respect of each sold lottery ticket and would include a unique ticket identifier 41, which could be a serial number or some other unique identifier in respect of the ticket for the purpose of keying the database.

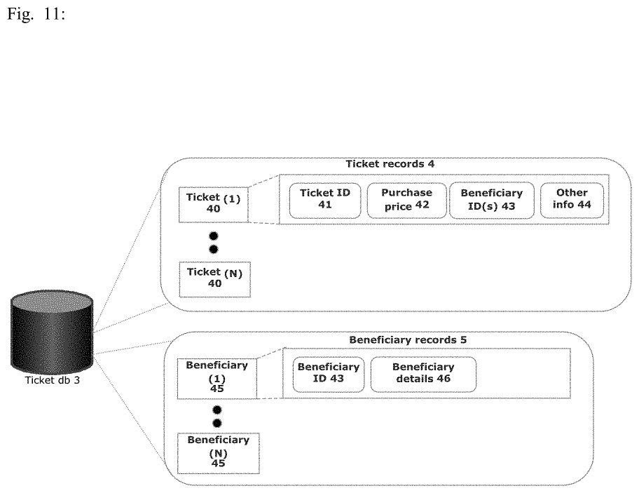

The ticket database 3, as shown in FIG. 11, contains a number of subsets of data and information which would be used in the execution of the method or operation of the lottery administration system of the present invention, including the following:
a) a ticket record subset 4, comprising a plurality of ticket records 40 each of which represents a lottery ticket sold in respect of a lottery administered in accordance with the invention;
b) a beneficiary record subset 5, comprising a plurality of beneficiary attribute records 45 each of which represent a lottery beneficiary who can be selected in respect of a ticket purchase in a lottery;
c) predetermined proceeds formulas, and other information.

Various types of data structures could be used in a ticket database 3 in accordance with the software method of the present invention and these are all understood to be within the scope of the present invention. Any type of a data structure capable of storing the various ticket and lottery attribute data outlined herein which is required for the execution of the remainder of the lottery administration system and the method of the present invention in conjunction with the software and hardware combination outlined will be within the scope of the present invention. In addition, there could be more types of data which would be stored in respect of individual customers or individual lotteries, beneficiaries, or tickets sold within the database 3 than are otherwise outlined herein and again those are all contemplated within the scope hereof.

The database 3 might comprise a single unitary data structure or might comprise a plurality of data structures either saved on one or more than server in a network environment.

The ticket database 3 might be resident on the server 2 or might alternatively be resident on or administered remotely within some type of a server farm database environment which was operably connected for communication with the server 2. The database 3 and its particular construction or data structure might also depend upon the infrastructure design of the remainder of the lottery administration system of the present invention and again the various aspects of the lottery administration system, its structure and the ticket database itself including those which are infrastructure-dependent will be understood to those skilled in the art of relational database and client/server system design. It is specifically contemplated that the ticket database 3 would most likely comprise an SQL database running on the necessary database server platform. Other tools and development environments can also be used however.

The first subset of information contained within the ticket database 3 is a dataset of ticket records. The ticket record subset 4 of the data in the database 3 is shown along with the plurality of ticket records 40. In this particular case the Figure is intended to demonstrate that there could be any number of ticket records 40 within the database, from 1 in quantity through N in quantity.

The contents of the ticket records 40 would vary in terms of the data structure dependent upon the overall data structure of the lottery administration system which was developed and implemented, although in the embodiment shown there are some basic information. Ticket record 40 which outlines some of the details of the lottery tickets to which each ticket record would pertain. In this particular case, and the ticket database 3 that is shown, the database 3 is intended to be relationally constructed in a way that the ticket records 40 could be relationally linked to the beneficiary attribute records 45 so that ticket record 40 corresponding to a particular sold lottery ticket could be directly linked to the attributes of one or more selected beneficiaries as represented by their beneficiary attribute records 45.

The first data token shown for demonstrative purposes in the ticket records 40 of this Figure is a ticket identifier 41. This would typically just be a database key or other serial identifier which could be used to identify a particular ticket record. Each lottery ticket which was sold in respect of a lottery being administered in accordance with the remainder of the lottery administration system and method of the present invention would have a ticket record 40 within the database 3.

In addition to a ticket identifier 41 there is next shown a data token representing the purchase price 42 of the related lottery ticket. In respect of lotteries in accordance with the remainder of the method of the present invention in which the ticket price did not vary, the purchase price 42 might be automatically substituted into the record rather than needing to capture it from the user, or might otherwise he can be hardcoded elsewhere in the database of the lottery administration system. It is contemplated though that the purchase price 42 of the lottery ticket will be stored in the ticket record 40 or in relation to the ticket record 40 for the purpose of calculation of total lottery proceeds and other items in the administration of the method. Even in a circumstance where the ticket price did not vary between tickets within a lottery, if the lottery administration system was being used to administer multiple lotteries with even multiple different fixed ticket prices, the purchase price field 42 would remain important.

The next data captured from the ticket sales system and stored in the ticket record 40 in respect of the sale of a particular lottery ticket is one or more beneficiary identifiers 43. The beneficiary identifiers 43 which would be stored in relation to the ticket record 40 would be the indicator of the at least one lottery beneficiary from a list of possible lottery beneficiaries that were selected by the purchaser, in accordance with the parameters of the lottery, at the time of purchase of the ticket and to whom the purchaser wish to have their portion of beneficiary proceeds attributable to their particular ticket purchased to be allocated at the completion of the lottery. The beneficiary identifier 43 as shown here is intended to demonstrate the relational nature of the ticket database 3 by being a relational key which could be used to connect the ticket record 40 to the beneficiary record subset 5 and a particular beneficiary record 45 pertaining to the beneficiary in question. It will be understood however that in other circumstances the beneficiary identifier might not link in the same way to a beneficiary record subset 5 as is shown here but could take some other format which would be useful from the perspective of the ticket level allocation of beneficiary proceeds which is conducted of the closure of the ticket sales window in accordance with the remainder of the method. Also shown is a data token 44 representing other information such as purchaser identifier details such as the name or address etc. of purchaser of the ticket if that were to be captured, or even other information that was required for the administration of the remainder of the method or for add-on purposes if there were for example side bets or other games associated with the lottery or other functionality was added alongside the pot sharing lottery method of the invention.

One of the things that could be contained as other information 44 in the ticket record 40 might be a field in which the actual lottery in which the ticket was purchased would be identified, since it is specifically contemplated that the lottery administration system and method of the present invention could be used as a service bureau to handle the administration of multiple lotteries on behalf of multiple parties and as such it would be desirable or required within the ticket record 40 to identify the particular lottery in respect of which a record was captured or created.

The second subset of records which is shown in the embodiment of the ticket database 3 shown in this Figure is a beneficiary record subset 5. As outlined above, in this embodiment of the database it is contemplated that a beneficiary attribute record 45 could be created in respect of each potential or possible lottery beneficiary, since it may be desirable from the perspective of the administration of the method to have within the relational database structure of the ticket database 3 a subset of records related to beneficiaries. Specifically where it was going to be desired to drive a user interface or maintenance related to the selection of beneficiaries by purchasers of tickets, a beneficiary attribute record subset 5 would be desirable and would be the likely way that those skilled in the art of database and software design would choose to implement this.

The beneficiary attribute record subset 5 which is shown comprises a plurality of beneficiary attribute records 45, each of which pertains to a potential or possible lottery beneficiary for a lottery which could be administered in accordance with the remainder of the present invention. The beneficiary identifier 43 is shown, being a serial key or the like attached to each beneficiary attribute record 45, and which can amongst other things be used to link to other tables in the database. Beneficiary details 46 are also shown. This might include things such as the name of the beneficiary, or even the key to the lottery or lotteries in respect of which a particular beneficiary should be provided in the user interface of the ticket sales system as a possible lottery beneficiary who can be selected by a ticket purchaser.

In a further embodiment of the ticket database 3, not shown, there might also be a lottery attribute record subset, which could be used to link ticket records and beneficiary records more specifically to particular lotteries being administered in accordance with the lottery administration system, particularly where the lottery administration system was intended to be used for the administration of multiple lotteries at the same time. Each transmission coming to the server for the creation of a ticket record 40 in the ticket database 3 would likely need to include a lottery identifier in this type of an embodiment, to identify the particular lottery in respect of which any data validation should take place and in respect of which the particular ticket record to be created would be stored.

### Ticket Sales System:

As outlined herein, ticketing server 2 would be in operative communication with a ticket sales system to facilitate the sale of lottery tickets in accordance with the remainder of the method of the present invention. The ticket sales system is specifically contemplated to take one of two configurations, the first of which would be that the ticket sales system comprises a plurality of ticket sales terminals 8 and related hardware and software, as is used in other site based lottery sales. Alternatively the ticket sales system might be a website system 10 which is used to facilitate the sale of lottery tickets in accordance with the remainder of the method—whereby either a vendor representative seeking to sell a lottery ticket, or even in a self-fulfillment approach that the customer themselves want to go on the website and simply purchase one or more lottery tickets in accordance with the remainder of the method, they can access the website using a client browser and effect the necessary interaction with the remainder of the ticket sales website as well as the ticketing server and the ticket database to finalize the purchase of tickets in accordance with the remainder of the method.

### Ticket Sales Terminal:

As outlined above, one embodiment of the ticket sales system contemplated by the present invention is a series of at least one ticket sales terminals 8. These would typically be lottery sales hardware that would otherwise be used for the sale of other types of lottery tickets which could be reprogrammed with modified software to allow for practice of the method of the present invention. The lottery administration system 1 demonstrated in FIG. 7 shows a plurality of ticket sales terminals 8, and FIG. 9 is a schematic diagram showing a basic block configuration of one ticket sales terminal 8 in accordance with the present invention. Many different types of hardware and software could be used in this type of an approach and all will be considered to be within the scope of the present invention—even the configuration of a smart phone, tablet or other device as a ticket sales terminal 8, by the incorporation of appropriate software or components therein, is contemplated within the scope of the present invention.

Referring to FIG. 9. Pre-existing ticket sales terminal 8 hardware could be repurposed with modified software for use in accordance with the remainder of this system and method of the present invention or purpose built hardware could also be used. The ticket sales terminal 8 includes one or more processors 30 and a memory 31. Similar to computer memory on the ticketing server 2, the memory on the ticket sales terminal 8 might include various types of processor instructions either for assistance in the execution of the method of the present invention or for other activities to be undertaken with the ticket sales terminal 8. The memory 31 would include a ticket sales software component 10 which is installed for the purpose of communicating with the ticketing server 2, and accomplishing the remainder of the method by providing the operator interface and enabling the operator of the ticket sales terminal 8 to interact with the purchaser and to sell lottery tickets in accordance with the remainder of this system and method of the present invention.

The ticket sales terminal 8 which is shown in this Figure also includes one or more input and output devices 32. This particular Figure shows the present of a screen 33, some type of a keyboard or other data entry means 34 by which the operator of the device 9 could interact with and enter information for capture. In some implementations, the ticket sales terminal 8 might also include a clock, location sensor or the like. Also present in the ticket sales terminal 8 would be a communications network interface 35 by which the ticket sales terminal 8 could communicate with the ticketing server 2 for the purpose of the transmission of sold ticket particulars related to lottery ticket sales transactions completed on that ticket sales terminal to the ticketing server 2, for the purpose of creation of ticket records 40 within the ticket database 3 with respect to tickets being sold by that ticket sales terminal 8.

The communications network interface 35 might use any type of network communication protocol depending upon the network infrastructure in question. In some implementations, the communications network interface 35 might be intended to send and receive data from the network wirelessly, and in other cases a wired network connection might be used. Some deployments of communications network 12 in accordance with the remainder of the present invention could foreseeably include both hard wired as well as wireless ticket sales terminals 8.

Insofar as the method of the present invention is built around the ability to remotely sell lottery tickets within a network environment, the ticket sales terminals 8 would need to include a ticket sales software program 10 which was capable of interacting with the remainder of the lottery administration system 1 of the present invention. The basic requirements of the ticket sales software 10 would be the need to interact with the software and hardware components resident on or connected to the ticket sales terminal 8 at the appropriate time to read or capture information from the operator in respect of a lottery ticket or tickets being sold including the purchase price and potentially the selection of beneficiaries for the ticket portion of beneficiary proceeds of the lottery, and to provide for the ability to transmit ticket particulars in respect of lottery ticket sales transactions back to the ticketing server 2. The ticket sales terminal 8 and the software component 10 would also work in conjunction with the software 6 on the ticketing server 2 to otherwise gather or assign the necessary information for the creation of ticket records 40 within the ticket database 2.

It is primarily contemplated that the ticket sales software 10 would be a freestanding local application on the ticket sales terminal 8—by creating a freestanding local application for use on the ticket sales terminal 8 there would be numerous benefits including the fact that the ticket sales terminal 8 would then not need to have constant network connectivity to the communications network 12 since it could store an offline subset of captured and generated sold ticket particulars for periodic upload when the network connection was available to the server 2 and the ticket database 3.

The method of the present invention could be practised using pre-existing ticket sales terminals 8 by the provision of a modified software component 10 for installation and operation thereon. Both the retrofit of existing ticket sales terminal 8 hardware as well as custom-built or purpose built new ticket sales terminal hardware 8 are contemplated within the scope hereof.

### Ticket Sales Website:

The second type of ticket sales system which is contemplated for use in accordance with the remainder of the method of the present invention, in place of or alongside the ticket sales terminals 8 outlined above, is the implementation of a ticket sales website system, whereby a website would be provided by which either a ticket seller or an individual purchaser wishing to facilitate or transact a sale of one or more lottery tickets in accordance with the remainder of the method of the present invention could do so via a website. Referring to FIG. 11, there is shown a ticket sales website system, which comprises a lottery sales Web server 10 operatively connected to the ticketing server 2 and the ticketing database 3 for the purpose of transacting ticket sales transactions. Ticket purchasers or ticket sellers would be able to access the ticketing Web server 10 via the client/server connection on the cloud 12 to the lottery sales Web server 10 from their client devices 15—the client device 15 could really be any device with a web browser installed thereon which was capable of communicating with the server 10.

The server 10 would contain the necessary content, hardware, software and processor instructions to interact with both the client devices 15 as well as the components of the ticketing server 2, for the purpose of facilitating ticket sales transactions. The server 10 could be freestanding server hardware, or in some embodiments could actually constitute an additional software component installed on the same physical server as the ticketing server 2. Both such approaches are contemplated within the scope of the present invention.

The specifics of the technical design of a website interface for use as a ticket sales website or a ticket sales system in accordance with the remainder of the method of the present invention will be easily understood to those skilled in the art of web site design. A Web server is populated with the necessary software instructions, content and the like, as well as rendered connected to the ticket database 3 and other necessary data stores, which will allow the Web server to display to ticket purchasers or users of the ticket sales system via a client device 15 which typically includes a browser, all of the necessary forms which are required to capture and generate information for the sale of lottery tickets in accordance with the remainder of the method of the present invention, and the transmission from the Web server to the ticketing server 2 of all of the necessary particulars, similar to transmissions to the ticketing server 2 by ticket sales terminals 8 in the other embodiments outlined of the ticket sales system herein, the necessary information and particulars such that the ticketing software component 6 on the server 2 can facilitate the creation of a ticket record 40 in the ticket database 3 corresponding to the ticket or tickets sold.

### Hybrid Ticket Sales System:

As outlined elsewhere above, it is also specifically contemplated that the ticket sales system that could be used in accordance with the remainder of the method and system of the present invention could be a hybrid system, including both the ticket sales website system as well as a plurality of ticket sales terminals. A hybrid system which would allow both for a self-service approach by which purchasers who wish to purchase one or more lottery tickets in accordance with the remainder of the present invention could access a website by which to do so, as well as a system which would accommodate the use of one or more ticket sales terminals 8 for the purpose of site based sales of lottery tickets in accordance with the remainder of the method is specifically contemplated within the scope hereof. The necessary changes to the remaining infrastructure of the ticket sales system and method of the present invention to accomplish or implement a hybrid sales system such as is described herein will be understood to be contemplated within the scope of the present invention will be understood by those skilled in the art of database, systems and software design.

Thus, it is clear that the described embodiments provide an enhanced pot sharing lottery system and method with commercial utility and market attractiveness. In addition, it will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

1. A method of conducting a pot-sharing lottery wherein the total sales proceeds of the lottery are allocated for distribution between at least one ticket purchaser and at least one of a plurality of possible lottery beneficiaries, said method comprising:
a. providing a ticketing server comprising:
i. a ticketing server software component for administering the method;
ii. a network interface via which the server can communicate with at least one ticket sales system for transacting the sales of lottery tickets to purchasers; and
iii. a stored proceeds formula for the lottery, which defines the allocation of the total sales proceeds of the lottery to a winner proceeds portion and a beneficiary proceeds portion;
iv. a ticket database comprising a plurality of ticket records each corresponding to a sold lottery ticket and containing at least:
1. the purchase price of the sold lottery ticket; and
2. at least one beneficiary identifier identifying a selected lottery beneficiary;
b. in a ticket sales step during a ticket sales window for the lottery, selling tickets to purchasers using the ticketing server and ticketing server software component by, for each sold lottery ticket:
i. receiving via the network interface from a ticket sales system a transmission including data corresponding to the purchase price of the sold lottery ticket and at least one beneficiary identifier identifying a selected lottery beneficiary selected from the plurality of possible lottery beneficiaries, selected by the purchaser of the sold lottery ticket; and
ii. creating a ticket record in the ticket database in respect of the sold lottery ticket and containing the purchase price and at least beneficiary identifier received;
c. in a proceeds allocation step occurring upon completion of the ticket sales step, allocating the lottery proceeds for distribution using the ticketing server and ticketing server software component by:
i. selecting from the ticket database the ticket records corresponding to all of the sold lottery tickets for the lottery, being the sold ticket record set;
ii. calculating total sales proceeds of the lottery by totaling the ticket purchase prices for each ticket record in the sold ticket record set;
iii. applying the proceeds formula to the total sales proceeds, to determine the winner proceeds portion and the beneficiary proceeds portion;
iv. allocating the winner proceeds portion to a selected number of winning tickets selected from ticket records in the sold ticket record set;
v. allocating the beneficiary proceeds portion amongst the plurality of possible lottery beneficiaries by, for each ticket record in the sold ticket record set:
1. calculating the amount of the beneficiary proceeds portion attributable to said ticket record, being the ticket beneficiary proceeds; and
2. allocating the ticket beneficiary proceeds to the selected lottery beneficiaries identified by the at least one beneficiary identifier within the sold ticket record; and
vi. displaying to a user of the server the allocated amount of total sales proceeds of the lottery payable to each selected winning ticket, and to each of the selected lottery beneficiaries.

2. The method of claim 1 wherein the sale of a sold lottery ticket further comprises the physical collection of purchase price funds corresponding to the ticket purchase price from the purchaser in addition to the creation of the related ticket record in the ticket database.

3. The method of claim 1 wherein the proceeds formula prescribes the calculation of the winner proceeds portion and the beneficiary proceeds portion of the total lottery proceeds.

4. The method of claim 1 wherein the proceeds formula prescribes the number of winning tickets which will be selected in the lottery, along with the allocation of the winner proceeds portion amongst the number of winning tickets to be selected.

5. The method of claim 1 wherein the purchase price for each sold lottery ticket is the same.

6. The method of claim 1 wherein the purchase price for each sold lottery ticket can vary, and can be selected by the purchaser at the time of ticket purchase.

7. The method of claim 1 wherein the number of selected beneficiaries which a purchaser can choose is the same for every sold lottery ticket.

8. The method of claim 1 wherein the number of selected beneficiaries which a purchaser can choose is variable.

9. The method of claim 1 wherein a ticket sales system comprises a ticket sales terminal having a user interface and ticket sales software by which an operator can sell lottery tickets.

10. The method of claim 1 wherein the ticket sales system comprises a ticket sales website operatively connected to the ticketing server, by which purchasers can purchase lottery tickets via website interactions.

11. The method of claim 1 wherein the ticket sales system presents a menu listing the plurality of possible lottery beneficiaries to the purchaser by a user interface of the ticket sales system, to allow the purchaser to select the permissible number of selected beneficiaries from the menu.

12. The method of claim 1 wherein the ticket records further comprise purchaser identity details, and the method of selling a sold lottery ticket includes the capture of purchaser identity details by the ticket sales system for subsequent storage in the corresponding record.

13. A ticketing server configured for use in the conduct of a pot-sharing lottery wherein the total sales proceeds of the lottery are allocated for distribution between at least one ticket purchaser and at least one of a plurality of possible lottery beneficiaries, the server comprising:
a. a non-transient computer-readable storage medium having executable instructions, being a ticketing server software component, embodied thereon along with a stored predetermined proceeds formula for the lottery, which defines the allocation of the total sales proceeds of the lottery to a winner proceeds portion and a beneficiary proceeds portion;
b. one or more hardware processors configured to execute the instructions;
c. a network interface via which the server can communicate with at least one ticket sales system for transacting the sales of lottery tickets to purchasers; and
d. a ticket database comprising a plurality of ticket records each corresponding to a sold lottery ticket and containing at least:
i. the purchase price of the sold lottery ticket; and
ii. at least one beneficiary identifier identifying a selected lottery beneficiary;
said server operable to:
a. in a ticket sales step during a ticket sales window for the lottery, sell lottery tickets to purchasers by, for each sold lottery ticket:
iii. receive via the network interface from a ticket sales system a transmission including data corresponding to the purchase price of the sold lottery ticket and at least one beneficiary identifier identifying a selected lottery beneficiary selected from the plurality of possible lottery beneficiaries, selected by the purchaser of the sold lottery ticket; and
iv. create a ticket record in the ticket database in respect of the sold lottery ticket and containing the purchase price and at least beneficiary identifier received;
b. in a proceeds allocation step occurring upon completion of the ticket sales step, allocate the lottery proceeds for distribution by:
i. selecting from the ticket database the ticket records corresponding to all of the sold lottery tickets for the lottery, being the sold ticket record set;
ii. calculating total sales proceeds of the lottery by totaling the ticket purchase prices for each ticket record in the sold ticket record set;
iii. applying the proceeds formula to the total sales proceeds to determine the winner proceeds portion and the beneficiary proceeds portion;
iv. allocating the winner proceeds portion to a selected number of winning tickets represented by ticket records in the sold ticket record set;
v. allocating the beneficiary proceeds portion by, for each ticket record in the sold ticket record set:
1. calculating the amount of the beneficiary proceeds portion attributable to said ticket record, being the ticket beneficiary proceeds; and
2. allocating the ticket beneficiary proceeds to the selected lottery beneficiaries identified by the at least one beneficiary identifier within the sold ticket record; and
vi. displaying to a user of the server the allocated amount of total sales proceeds of the lottery payable to each selected winning ticket, and to each of the selected lottery beneficiaries.

14. The ticketing server of claim 13 wherein the proceeds formula prescribes the calculation of the allocated portion of total sales proceeds of the lottery that is the winner proceeds portion, and the allocated portion of the total sales proceeds of the lottery that is the beneficiary proceeds portion.

15. The ticketing server of claim 13 wherein the proceeds formula prescribes the number of winning tickets which will be selected in the lottery, along with the allocation of the winner proceeds portion amongst the number of winning tickets to be selected.

16. The ticketing server of claim 13 wherein the purchase price for each sold lottery ticket is the same.

17. The ticketing server of claim 13 wherein the purchase price for each sold lottery ticket can vary, and can be selected by the purchaser at the time of ticket purchase.

18. The ticketing server of claim 13 wherein the number of selected beneficiaries which a purchaser can choose is the same for every sold lottery ticket.

19. The ticketing server of claim 13 wherein the number of selected beneficiaries which a purchaser can choose is variable.

20. The ticketing server of claim 13 wherein a ticket sales system comprises a ticket sales terminal having a user interface and ticket sales software by which an operator can sell lottery tickets.

21. The ticketing server of claim 13 wherein the ticket sales system comprises a ticket sales website operatively connected to the ticketing server, by which purchasers can purchase lottery tickets via website interactions.

22. The server of claim 21 wherein a web server for operation of the ticket sales website is integrated in the ticketing server.

23. The ticketing server of claim 13 wherein the ticket sales system presents a menu listing the plurality of possible lottery beneficiaries to the purchaser by a user interface of the ticket sales system, to allow the purchaser to select the permissible number of selected beneficiaries from the menu.
